(19) United States
(12) Patent Application Publication
(10) Pub. No.: US 2002/0173999 A1
(43) Pub. Date: Nov. 21, 2002

(54) Performance management system

(76) Inventors: Edward R. Griffor, Grosse Pointe Park, MI (US); Daniel William Russie, Clawson, MI (US)

Correspondence Address: JAMES D. STEVENS, REISING, ETHINGTON, BARNES, KISSELLE, ET AL, P.O. BOX 4390, TROY, MI, 48099, US

(21) Appl. No.: 09/825,782

(22) Filed: Apr. 4, 2001

(51) Int. Cl. G06F 17/60

(52) U.S. Cl. 705/7

(57) ABSTRACT

A computer-based performance management system that can be used as an adjunct to organizational consulting processes. Organizational goals are each separated into a plurality of different levels of elemental components, with the components at each successively lower level provide a greater degree of specificity concerning the organizational activities required to achieve the goal. The elemental components at the bottom level comprise deliverables that represent organizational accomplishments required to achieve the organizational goal. Relationships between elemental components at different levels are recorded using specification tables to represent those relationships. In this way, the relationship between a deliverable and its associated organizational goal is represented by a combination of some or all of the arrays. The system permits determination of individual roles for participants in the organization with these roles being represented by its associated deliverable, one or more specified skills, and a numerical value indicative of the amount of the participant's time required to produce the deliverable. The system utilizes digitally based data storage to store data concerning the elemental components and actual organizational performance. The system also manages and stores fulfillment data that is used by the system to assist in managing organizational performance in a manner that will achieve the desired goals. The fulfillment data is managed using a buyer-seller transactional model that operates on action rules built from the elemental components recorded in the specification tables. The action rules define the relationships between elemental components using mathematical weightings to quantitatively define their relative importance to the organizational goals.

### TECHNICAL FIELD

This invention relates generally to computer management of organizational performance and, in particular, to management tools that collect, collate, process and present a synthesis of information about the required performance components of an organization to its participants at all levels.

### BACKGROUND OF THE INVENTION

Performance management within an organization has historically been handled using a myriad of different business process approaches. These approaches tend to have varying benefits depending upon the particular type of organization and its employees (or, more generally, participants). For example, in the field of manufacturing and particularly assembly line manufacturing, performance management may tend to focus on techniques for improving the rate and repeatability of a particular action by a particular participant (e.g., how to obtain the fastest, consistent assembly of a bolt onto a screw thread). However, the conventional approaches for this manufacturing process do not lend themselves well to information management, especially where a primary goal of the performance management is to extract or synthesize only the relevant information from among a much larger collection of diverse information.

Traditional management assistance technology has typically had as its basic function information management. Such services gather information from various levels of an organization's operations for use and evaluation at a management level above those operations. For example traditional appraisal technology, both text-based and computer software tools, is performance historical. It typically is put in place for purposes of facilitating compensation and development decisions and not for the purpose of providing performance contemporaneous support tools, i.e., real-time access to performance evaluations for the purpose of facilitating satisfactory performance levels.

### SUMMARY OF THE INVENTION

In accordance with the present invention, there is provided a computer-based performance management system that can be used as an adjunct to organizational consulting processes to improve management of organizational performance and help maintain alignment between actual performance and defined organizational goals. The organizational goals are each separated into a plurality of different levels of elemental components, with the different levels including a top level, a bottom level, and one or more intermediate levels. The elemental components at each successively lower level provide a greater degree of specificity concerning the organizational activities required to achieve the goal than the elemental components at the preceding level. The elemental components at the bottom level comprise one or more sets of deliverables that represent organizational accomplishments that are required to achieve the organizational goal. The relationships between elemental components at the different levels are recorded using a plurality of specification tables or other arrays to represent those relationships. In this way, the relationship between a deliverable and its associated organizational goal is represented by a combination of some or all of the arrays.

In accordance with another aspect of the invention, the system permits determination of individual roles for participants in the organization a defined set of deliverables that have been identified as being required to achieve one or more organizational goals. This is accomplished by determining, for each of the deliverables, one or more individual roles for a participant within the organization, and representing each individual role using its associated deliverable, one or more specified skills, and a numerical value indicative of the amount of the participant's time required to produce the associated deliverable using the specified skill(s).

In accordance with yet another aspect of the invention, the system utilizes digitally-based data storage to store a first set of data concerning the elemental components at the different levels, a second set of data concerning the actual performance of organizational participants, and a third set of data concerning sequences of transactions that track completion of the deliverables and attainment of the organizational goals. The system manages this third set of data using data from the first two sets. The first set of data can be derived from the specification tables or other arrays used to record the relationships between the elemental components. This data can be stored as a set of action rules that define those relationships using mathematical weighting to quantitatively define their relative importance to the organizational goals. Management of the third set of data can be carried out using a marketplace-based model in which achievement of the elemental components at the different levels and, thus, the organizational goals is processed using the paradigm of buyer-seller economic transactions.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is an overview of the performance management consulting process with which the computer-based tools of the present invention are used;

FIG. 2 depicts the overview of FIG. 1 showing the portions of the process at which data is captured and used by the present invention;

FIG. 3 is a block diagram showing a preferred embodiment of the performance management software tools of the present invention that can be used in conjunction with the consulting process outlined in FIG. 1;

FIG. 4 is an overview of the specification tables used to define individual roles for participants in the organization based on a decomposition of the defined organizational goals;

FIG. 5 depicts a complete set of the specification tables as they might be used for a typical large (multi-divisioned) organization;

FIGS. 6-45 depict various ones of the specification tables and together these figures show how those tables are constructed and then used as a part of the performance management consulting process of FIG. 1; and

FIG. 46 is a block diagram and flow chart depicting the action rule module that provides the transaction logic shown in FIG. 3.

### DETAILED DESCRIPTION OF THE PREFERRED EMBODIMENTS

### Overview

The method of this invention extends the traditional use of systems providing access to administrative information (e.g., performance appraisal aids). This invention provides the information gathering and processing technology necessary for managing performance at all levels of an organization. The resulting appraisal technology is linked in this way through successive levels of an organization directly to the goals of the organization. By focusing all resource allocation and development on achieving the organizational goals of the organization, it provides aligned metrics for measuring the difference between the competencies required by the organization's strategic plans and the skill based resources available in its participants. At the same time the method of this invention manages all training and learning resources available as a part of the organization's intervention model, since their value is measured relative to their impact on performance. Thus the aligned metrics on performance induce metrics on training and learning resources. In summary, this invention provides a complete environment for: recording and structuring the information produced by the definition phase of the organizational consulting process; and the implementation and maintenance of the alignment of organizational operations with its organizational goals.

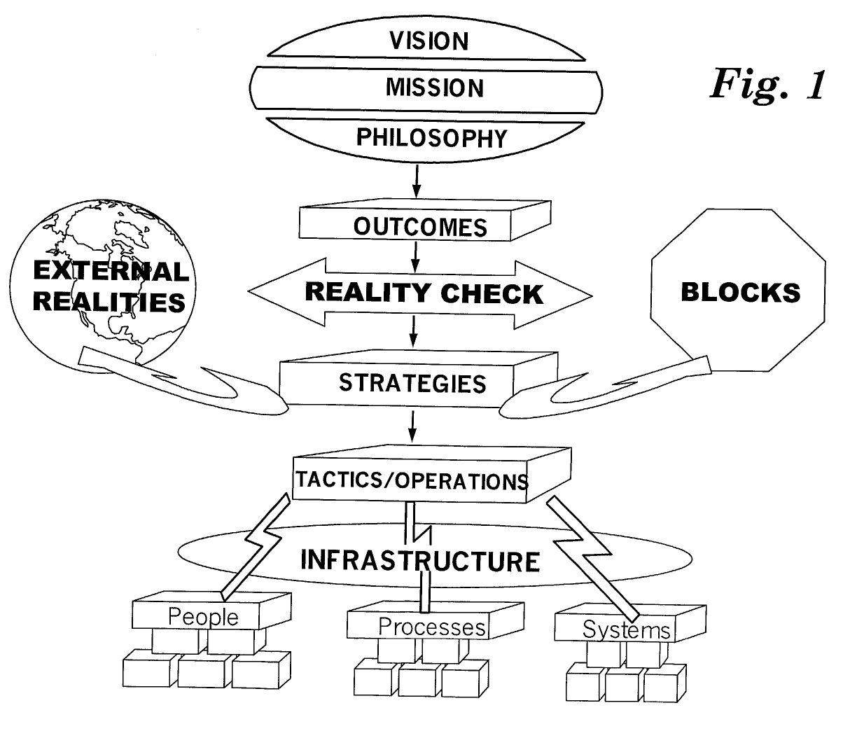

FIG. 1 exhibits graphically a consulting process with which the present invention can be used. The consulting process provides assessments of the different components of an organization both for purposes of information and for intervention aimed at alignment of the organization with its purposes. Intervention for purposes of realignment, i.e., action to bring performance back into alignment with its purpose is the basis of the feedback mechanism of this technology. This general structure creates this system's internal model of the organization's vision. That model consists of action rules that reflect the organizational goals of the organization.

The consulting process of FIG. 1 involves a determination of the organization's goals, followed by a breakdown of those goals into successively more detailed levels of implementation until they are completely decomposed into a set of deliverables and individual roles for participants within the organization. The deliverables represent specific organizational accomplishments that are required to achieve the organizational goals. The individual roles represent the different responsibilities that each participant has in working toward the accomplishment of one or more of the organizational goals. These individual roles permit all participants to identify the deliverables for which they are responsible along with the skills and time commitment required of them to achieve the deliverable. Using the computer-based technology of the present invention, the voluminous amounts of information that are often generated by the consulting process can, in essence, be filtered to remove the irrelevant information and synthesize out only that which is needed at any time to maintain alignment of the organization's performance with its goals.

In terms of the consulting process, the organizational goals can be embodied in a statement that addresses three different sectors —vision, mission, and philosophy of the organization. To determine the deliverables and individual roles and their relative contribution to achieving the organizational goals, the goals are separated into different levels of elemental components, with the elemental components at each successive level providing a greater degree of specificity concerning the organizational activities required to achieve the goal than the elemental components at the preceding level. This breakdown, or decomposition, continues until specific deliverables have been determined, at which point the deliverables are used to determine the individual roles required of the participants within the organization. As indicated in FIG. 1, the elemental components can include outcomes which, after a review for reasonableness and an analysis of what is preventing their achievement (blocks), are then separated into other intermediate level components, such as strategies (i.e., general courses of action to overcome blocks and achieve outcomes) and then tactics and operational elemental components. At any one or more of these levels, the identified elemental components can be subjected to sanctioning, wherein management reviews (certifying agreement that they will satisfy the requirements of the preceding higher level components) the identified components, either committing to them (and thereby permitting continuing decomposition of the elements) or rejecting them, in which case a different breakdown of the elements must occur at the higher levels until it results in an approved set of components. Finally, the tactical and operational elemental components are tied to the organization's infrastructure so that they can be separated into the specific deliverables required of the various participants, processes, and systems of the organization.

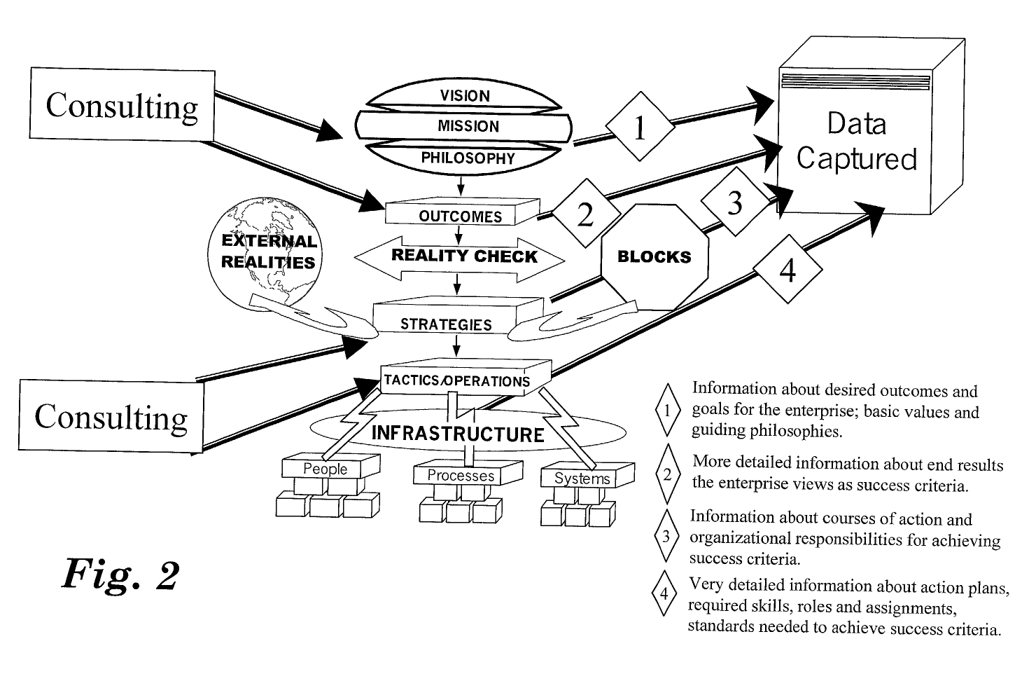

As shown in FIG. 2, information arising out of this consulting process is captured at each definitional stage (i.e., at each level of elemental components) by a computer-based system that records, manages, and processes the information in a manner which enables the system to assist the performance management of the organization in a number of different ways, including: 1) quantitatively measuring of the importance of the resulting deliverables and individual roles on the ultimate goals of the organization; 2) providing action rules that can be used by participants to maintain alignment of their individual roles with the organizational goals, and 3) providing a framework for the automated determination of organizational success based on actual performance as defined by the deliverables and/or other elemental components using a buyer/seller transactional model. These features will be discussed in greater detail below in connection with the consulting process of FIG. 1. However, it will be appreciated as the description proceeds that the invention can be used with various other consulting techniques that involve a determination of specified requirements needed to achieve higher level goals and that the invention is thus not limited to the specific consulting process disclosed.

### Performance Management System Design

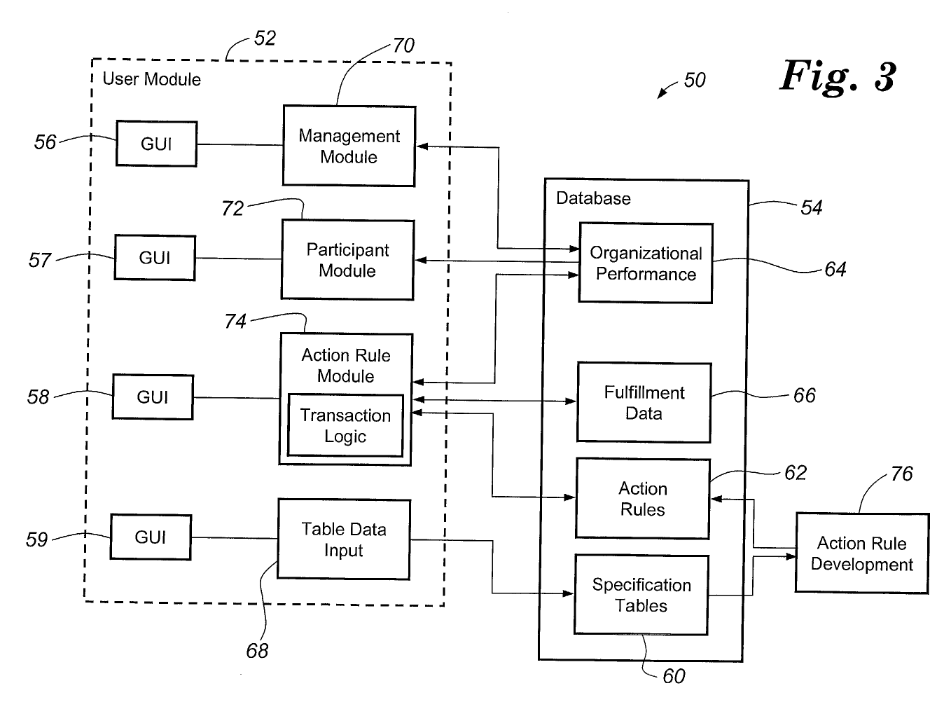

Referring now to FIG. 3, there is shown a diagrammatic view of the construction of a preferred embodiment of a performance management system 50 of the present invention. In general, the system 50 includes a user module 52 and database 54, with the user module 52 containing the main programming of the system as well as various graphical user interfaces 56-59 for the inputting of data, the querying of the database, and the reporting of various information to participants within the organization. The database includes various sets of data which, as will be appreciated by those skilled in the art, can be stored together as a single database 54, or can be separated into different databases on or across different local or distributed computer platforms. Preferably, the system 50 would be implemented in a client/server configuration (whether over a private computer network, a global public network such as the Internet, or some other configuration) with the database and business rules logic being implemented primarily on the server and the user interfaces 56-59 being implemented on the client computers.

The database 54 includes a set of specification tables 60 that are constructed during the definitional phase of the consulting process. These specification tables 60 are populated with data concerning the elemental components and their quantitative measures of importance to the organization. Once constructed, the information stored and organized within the specification tables 60 is used to develop action rules 62 that are stored in the database 54. These action rules 62 represent the relationship set forth in the specification table 60 between an individual elemental component and the associated components from the next lower level. They are used to provide information about the performance requirements necessary to satisfy the various elemental components derived from the organizational goals. They are also used to determine the extent to which the achieved performance requirements are contributing to the realization of the goals (fulfillment). Both this performance and fulfillment data is stored within database 54 as separate sets of data 64 and 66, respectively. The specification tables 60 and action rules 62 will be described below in greater detail.

The user module 52 includes a specification table data input module 68 for recording the information needed to construct and populate the specification tables 60. The user module 52 also includes three main modules that provide different interfaces for use by participants within the organization. These modules are the management module 70; the participant module 72; and the action rule module 74. Each includes one of the graphical user interfaces 56-59 which of course could be implemented together as part of a single process that provides access to any of the modules within the user module 52. The management module 70 is provided for use by upper level management to monitor whether the organization is maintaining proper alignment of the activities of the organization with the organizational goals. The participant module 72 is provided for use by organizational participants at all levels to identify their individual roles, give feedback on their individual performance, and to indicate how their role fits into achieving one or more of the organizational goals. The action rule module 74 provides an interface into the action rules 62 developed from the specification tables 60, as well as to actual performance data 64 that has been fed back into the system. Action rule module 74 performs two primary duties: (1) providing information to participants concerning what actions can be taken to help achieve the organizational goals; and (2) management and processing of data concerning actual organizational performance (e.g., achievement of deliverables) to adaptively determine both the success in realizing organizational goals and the elemental components that best contributed to that success.

### Specification Tables

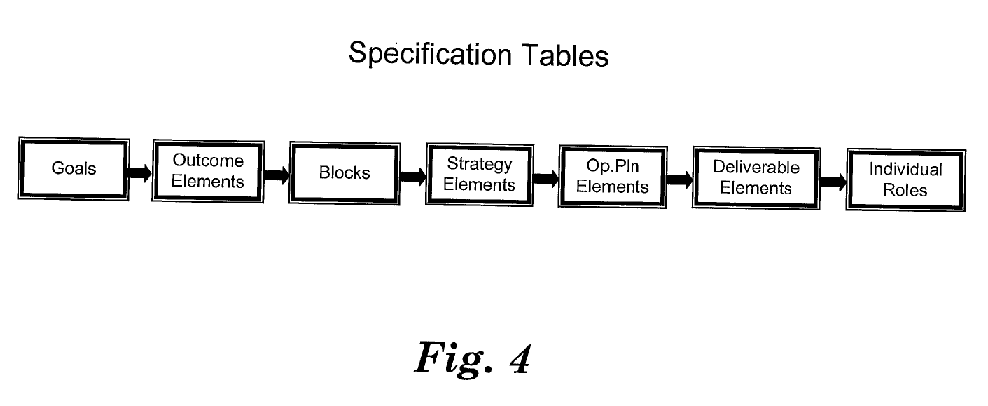

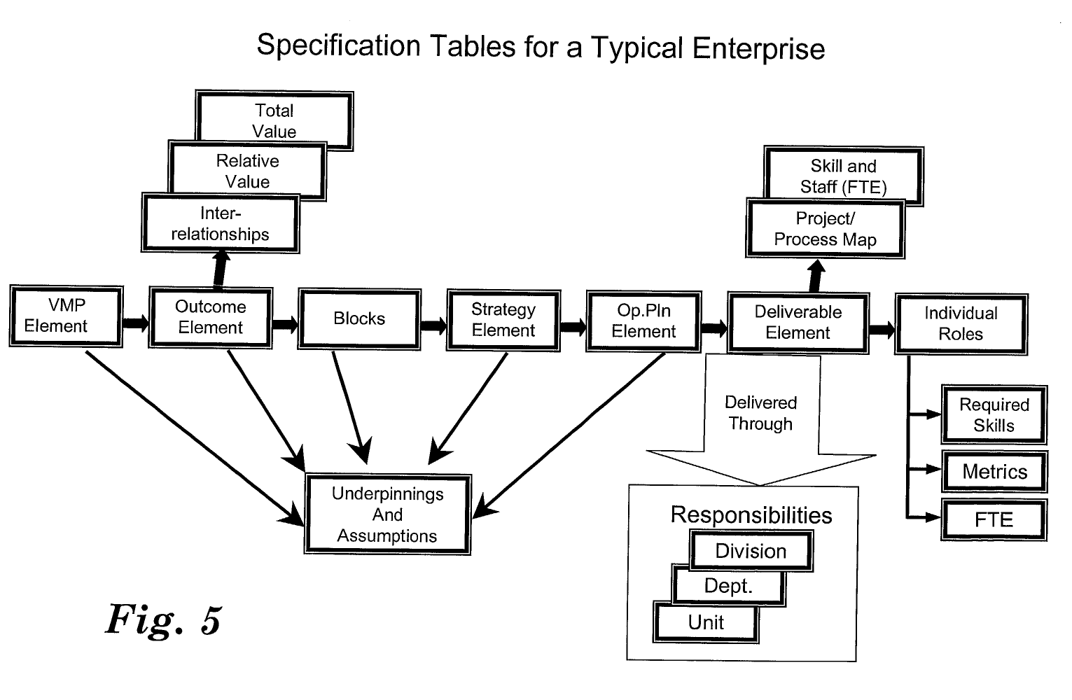

The specification tables 60 are a method of gathering and organizing the information generated during the definition phase of the organizational consulting process. In general, a table is constructed for each breakdown of a goal or elemental component at one level into elemental components at the next lower level. A simple sequence of these tables is shown in FIG. 4 and it will be appreciated that these tables correspond to the different levels of organizational definition shown in FIGS. 1 and 2. The extent, i.e., number and content of these tables, depends entirely on the nature of the organization being analyzed. For example, FIG. 5 depicts a typical set of specification tables as they would be generated during the consulting process of FIG. 1 for an enterprise having multiple divisions (operating units). These tables, once constructed, provide a means of describing the connection between any element of an organization's goals and the derived components at any level of the definition phase of the organizational consulting process, e.g. between a top level goal and a deliverable occurring in operational plans. In this regard, it should be appreciated that the specification tables are a means of recording the results of having applied the consulting method rather than some fixed set of tables that have to be completed. Thus, the construction, content, and number of tables will be determined as a part of the consulting process and will be different for each organization.

The construction of the specification tables includes the actual construction of the elements of the table's two axes. This step corresponds to the sanctioning/commitment step of the definition phase of the organizational consulting process. The tables represent both the qualitative and quantitative relationship between components at different levels, with the horizontal axis containing higher level components and the vertical axis containing the succeeding level components that have be determined as contributing to one or more of the higher level (horizontal axis) components. The specification tables aid in defining these relationships in two ways:

1) Specifying the elements of the vertical axis of a table is a qualitative judgment of what factors contribute to the horizontal axis elements (the latter being sanctioned during the construction of the vertical axis of the preceding table).

2) Determining the contribution of a vertical axis element to the weight assigned to a horizontal axis element. This is done in such a way that the sum down any column equals the weighting of that column's horizontal axis element. This is a judgment of the importance of each vertical axis element in realizing the horizontal axis elements.

### Specification Table Construction

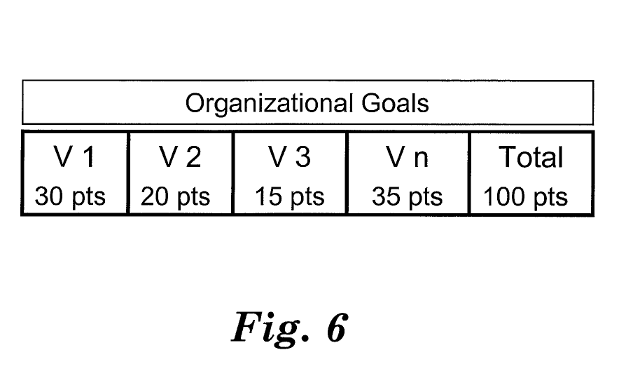

The generation of the specification tables consists of iterating the routine for each table constructed. The following description is of the iteration for the first of the tables with organizational goals on the horizontal axis and outcome elements on the vertical axis, but the procedure described is a completely general description of how one produces one of the specification tables given the previous one. A set of exemplary organizational goals and their relative weighting (which have been determined during the consulting process) is shown in FIG. 6. The four stages of table construction are as follows, with the operation being carried out being identified in parentheses:

I. (List Creation) This stage consists of three steps whose final result is a list of contributory elements about which there is true consensus:

1. (List Formulation) Every participant is asked to describe the elements of the image brought about by considering the definition of the organizational goals through all the previous levels (as recorded in the previous tables); all of the participants' contributions are then consolidated as a single list.

2. (Add, Combine and Modify List Elements) Brainstorming where the list provided by the previous stage can be augmented, elements can be combined and existing elements can be modified

3. (Add, Remove, Combine, Modify producing Commitment) A normative check identifying and resolving consensus blocks employing the true consensus process on the resulting list.

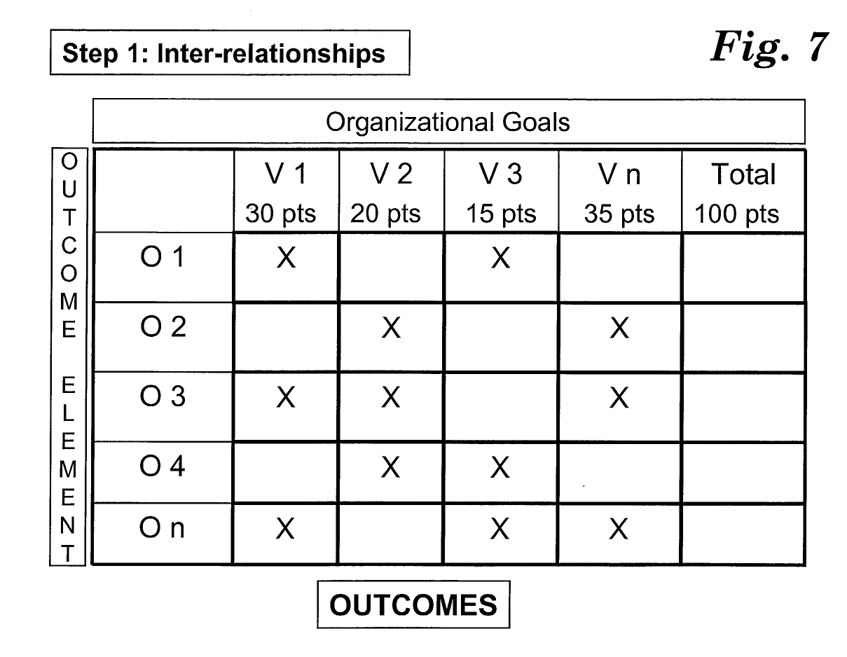

The result of this first stage is an identification of the vertical axis elemental components at the next lower level which contribute to the horizontal axis components. Thus, as shown in FIG. 7 for the specification table representing the relationship between the goals and outcomes, it has been determined that outcomes (o₁, . . . oₙ) are required to achieve goals (V₁, . . . Vₙ). Thus, the table is initially constructed with the higher level elemental components (goals V₁, . . . Vₙ) on the horizontal axis and the next lower level components (outcomes o₁, . . . oₙ) on the vertical axis.

II. (Interrelationships) This stage is used to determine whether vertical axis elements contribute to horizontal axis elements other than the one that led to its being included on the list resulting from first stage, i.e., whether they collaborate. The desired result of Stage I is a list of elemental components that satisfies three requirements that together indicate that the list of components is appropriate:

a) Comprehensive

b) Universal commitment by participants

c) Sanctioned (approved by management)

To complete Stage II, the following two steps are carried out:

4. (Initial X's) Insert the first set of X's indicating the initial identification that they contribute to a horizontal axis element.

5. Use the answers to the question “Do any vertical axis elements contribute to horizontal axis elements other than the source of initial X's?“ Such X's are referred to as collaborative X's. Having inserted X's marking those collaborative X's, the resulting set of X's is shown in FIG. 7.

It is worth noting here that the primary block to collaboration has been removed when Stage I resulted in commitment, i.e., as a result of the organizational consulting process producing a collaborative result.

III. (Value Assessment) This stage is used to determine the weights wᵢⱼ that indicate the relative importance of the contribution of a vertical axis elemental component to each of the horizontal axis components to which it contributes. This stage involves the following two steps.

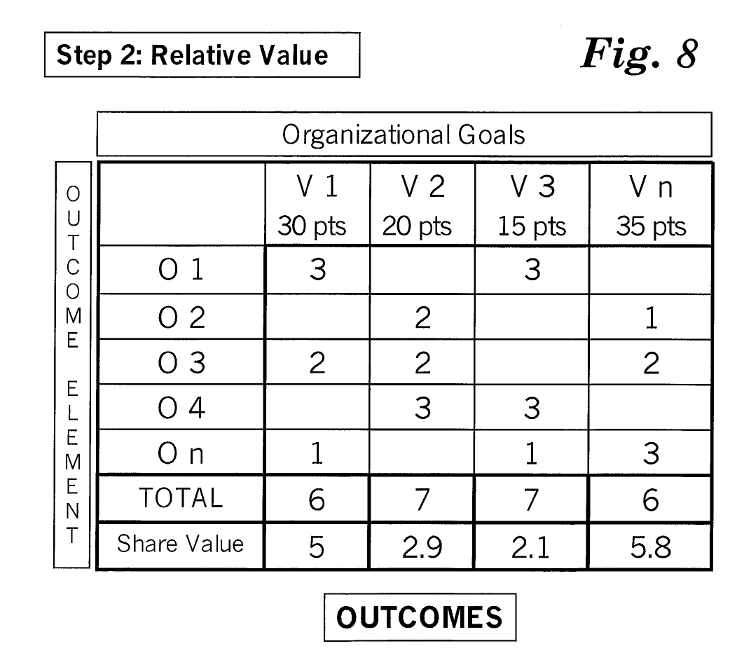

6. (Relative Value) Given an organizational goal Vⱼ (horizontal axis element), the participants assign (by consensus) rankings of 1 (contributory), 2 (significant) or 3 (mandatory) to each outcome below Vⱼ with an X (0 is assigned to positions without an X). This is shown in FIG. 8. The ranking assigned to oᵢ is denoted by rᵢⱼ;

7. (Total Value) Let w(Vⱼ) denote the weight associated with the goal Vⱼ and set wᵢⱼ=rᵢⱼ x share(Vⱼ) where:

$$share ( {V}_{j} ) = \frac{w ( {V}_{j} )}{{\sum }_{i = 1}^{t} {r}_{ij}} \qquad ( 1 )$$

IV. (Weight Assignment) In this stage, the weights are substituted for the X's recorded in the specification tables that satisfy vertical requirement and a horizontal requirement.

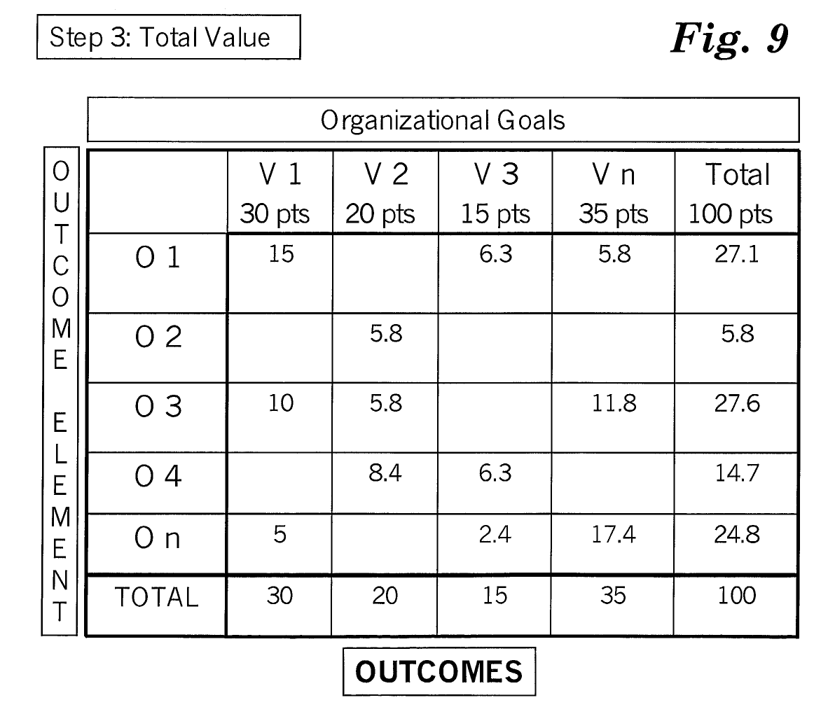

This is shown in FIG. 9. If the weighting is done from the top down (i.e., starting with the organizational goals), each previous table (from which the vertical axis components are taken and used to occupy the horizontal axis) was accompanied by weights for each horizontal axis components whose sum is (normalized to) 100:

8. (Vertical Requirement) Given a vision element V and its weight K and the list of vertical axis elements o₁, . . . oₗ, the weights are selected for each oᵢ, called w(oᵢ), in such a way that:

$${\sum }_{i = 1}^{l} w ( {o}_{i} ) = K \qquad ( 2 )$$

For all positions (j,t) where oⱼ does not contribute to Vₜ, those positions are set equal to 0.

9. (Horizontal Requirement) Let Vᵢ, . . . Vₛ be the list of all vision elements, and define:

$${\sum }_{r = 1}^{s} {w}_{jr} = {Ω}_{j} ; \qquad ( 3 )$$

we require that the sum of the total contributions of all outcomes is equal to 100 (where t is the total number of elements on the list produced by Stage I):

$${\sum }_{j = 1}^{t} {Ω}_{j} = 100 \qquad ( 4 )$$

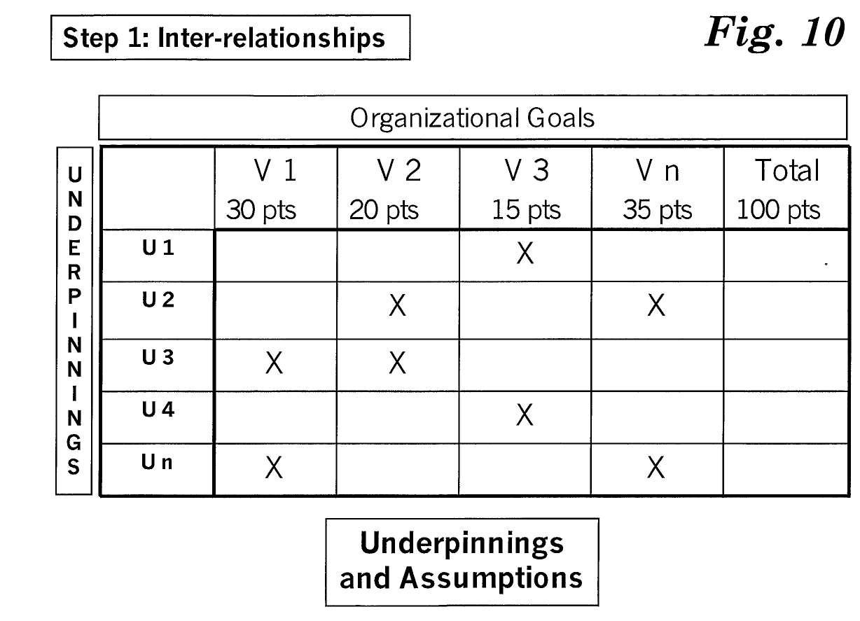

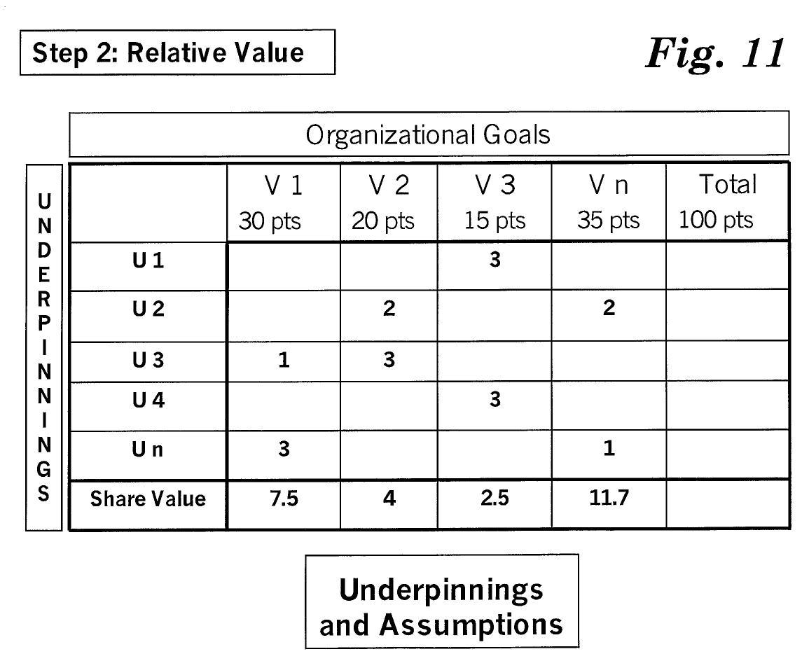

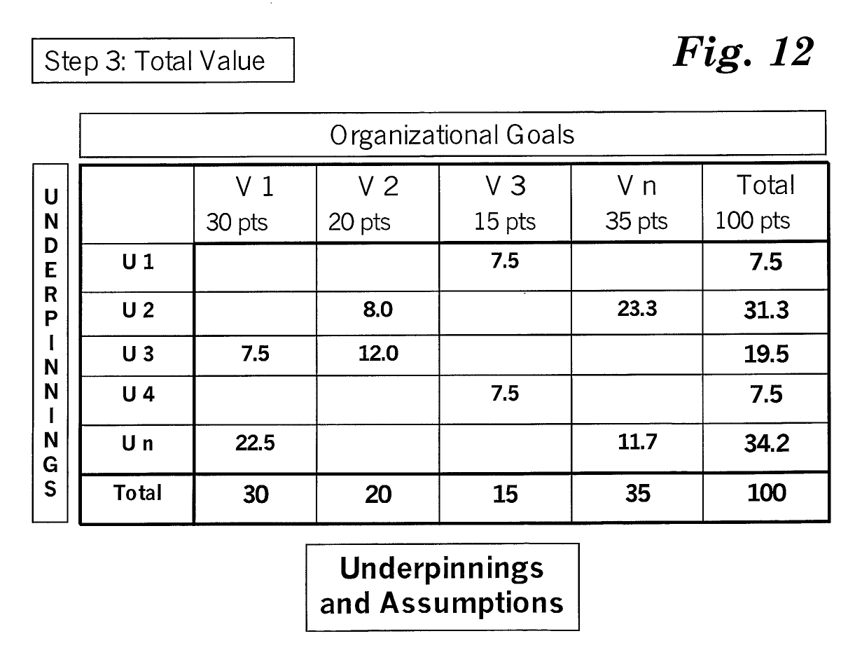

This same four-stage process is repeated for each of the interrelationships between elemental components at adjacent levels. The resulting weights can then be used in constructing the action rules and are used in determining the value of the action rules, as will be discussed farther below. In FIGS. 10-12, an example of table construction is provided for the underpinnings and assumptions which, as shown back in FIG. 5, is a separate branch path to identify the underpinnings and assumptions on which the decomposition of the organizational goals through the different levels depends. The use of these underpinnings and assumptions will be explained further below.

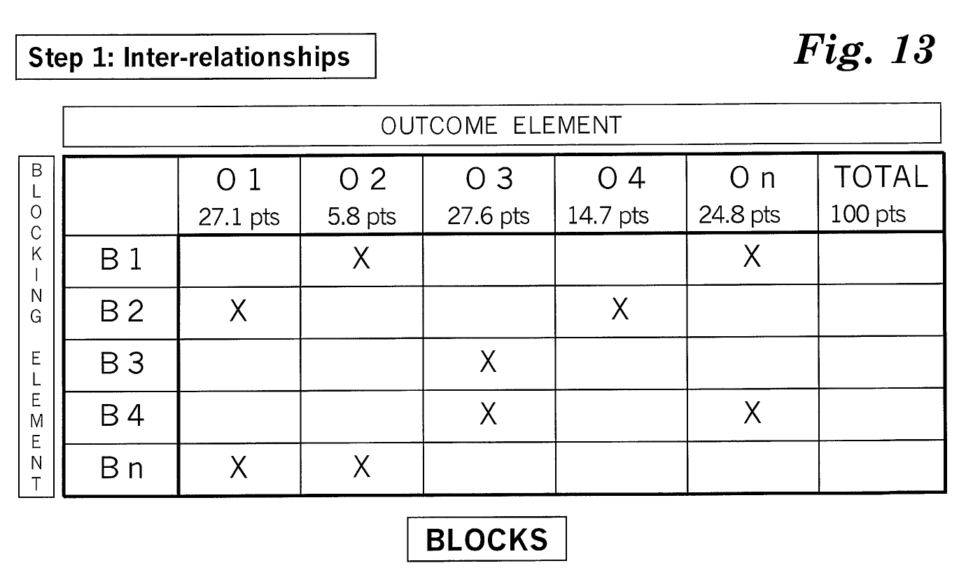

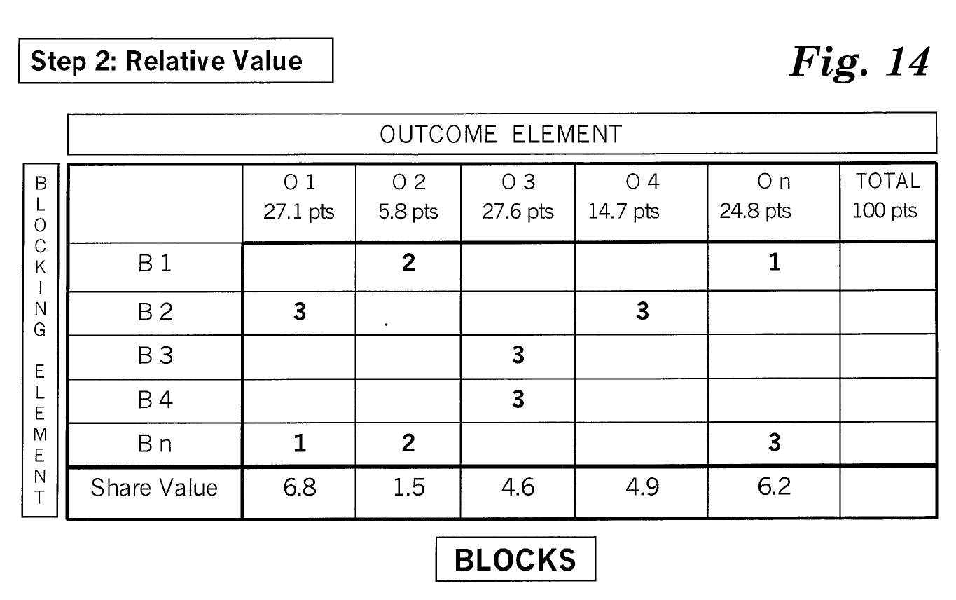

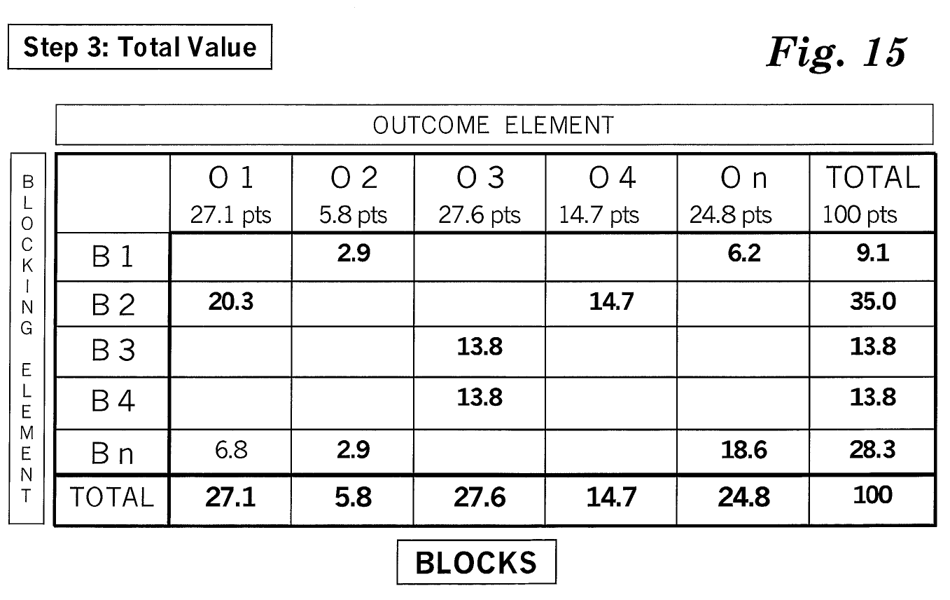

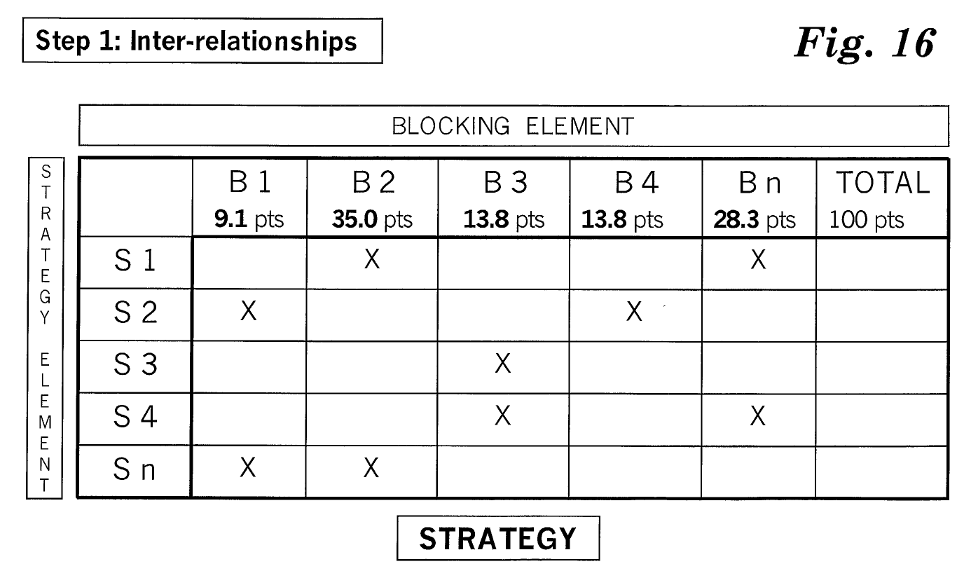

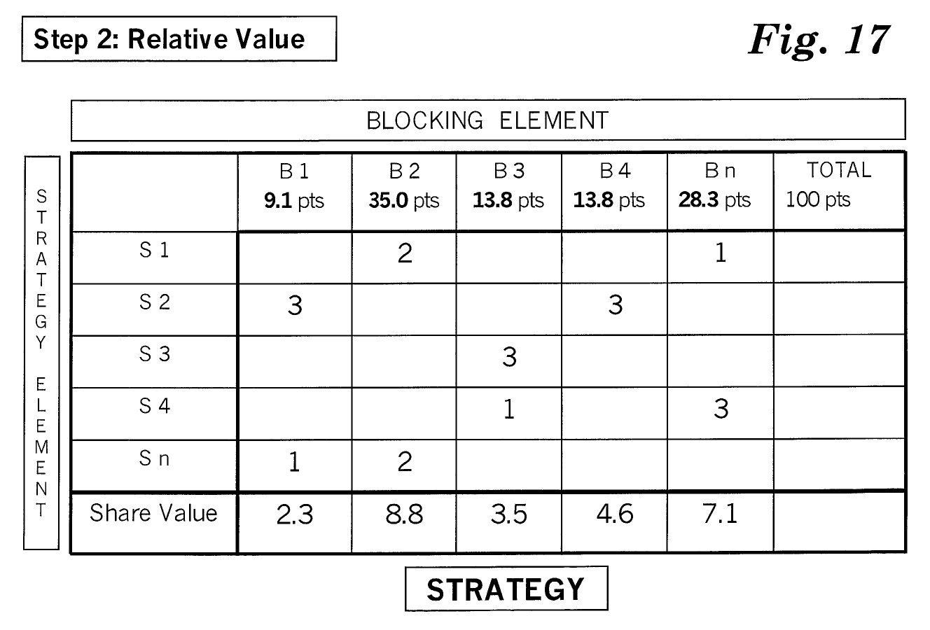

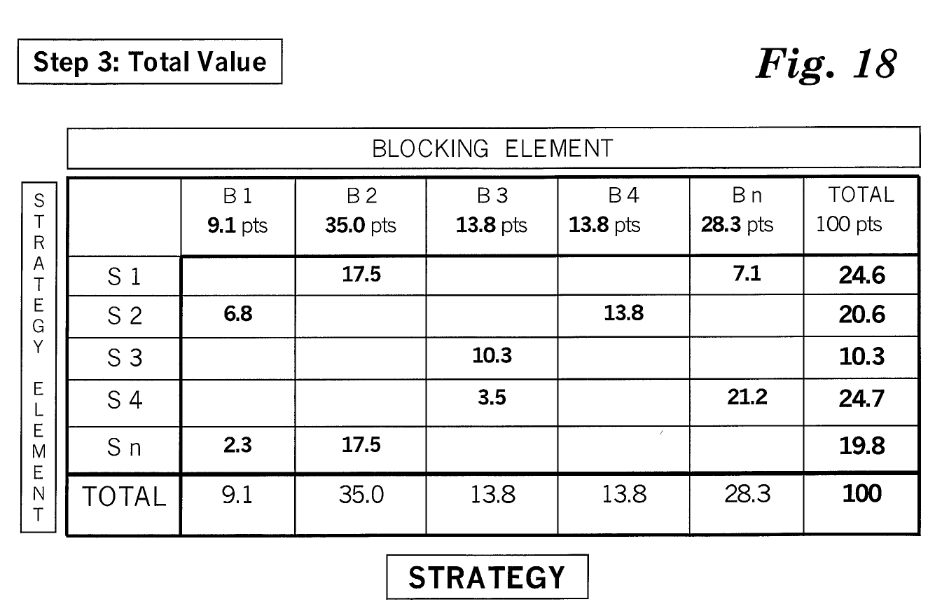

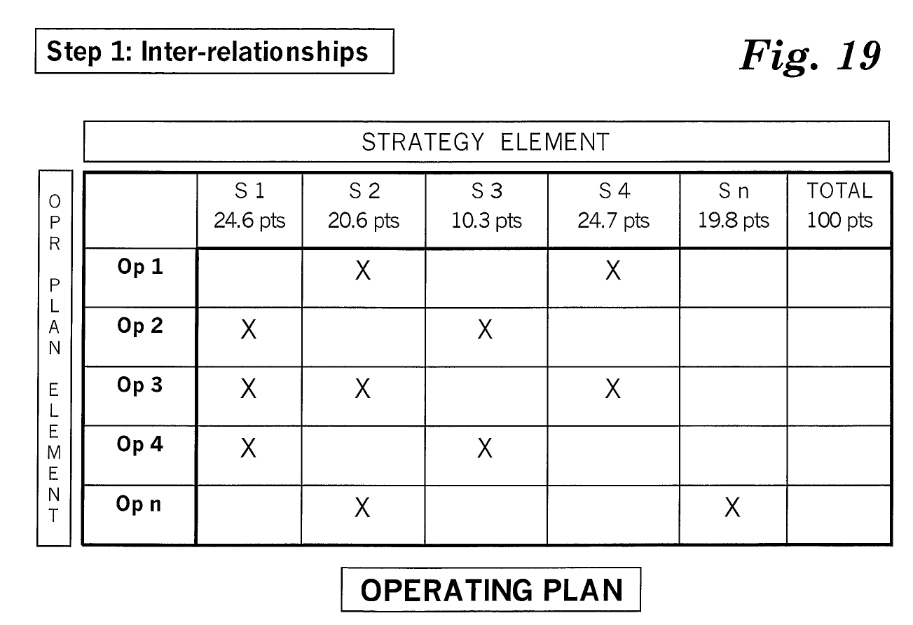

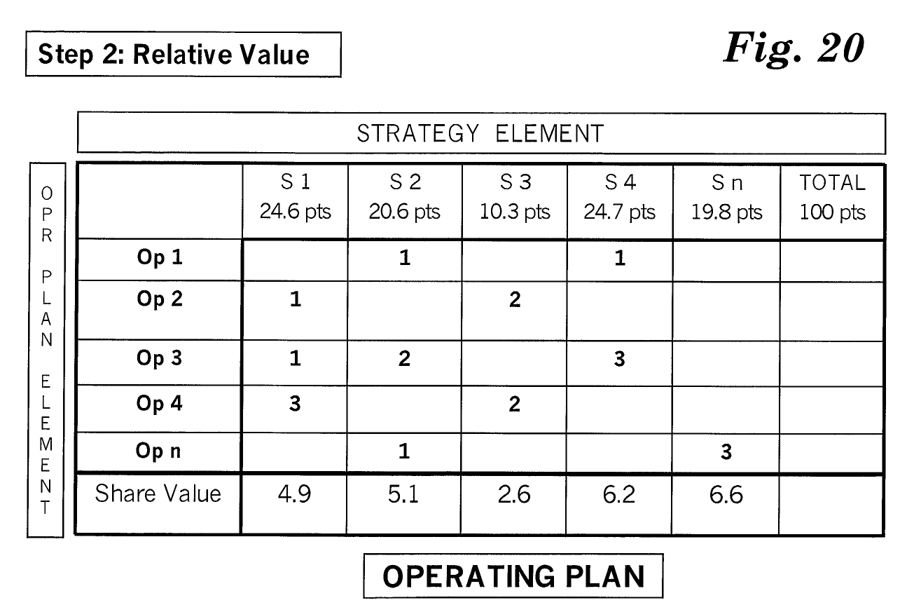

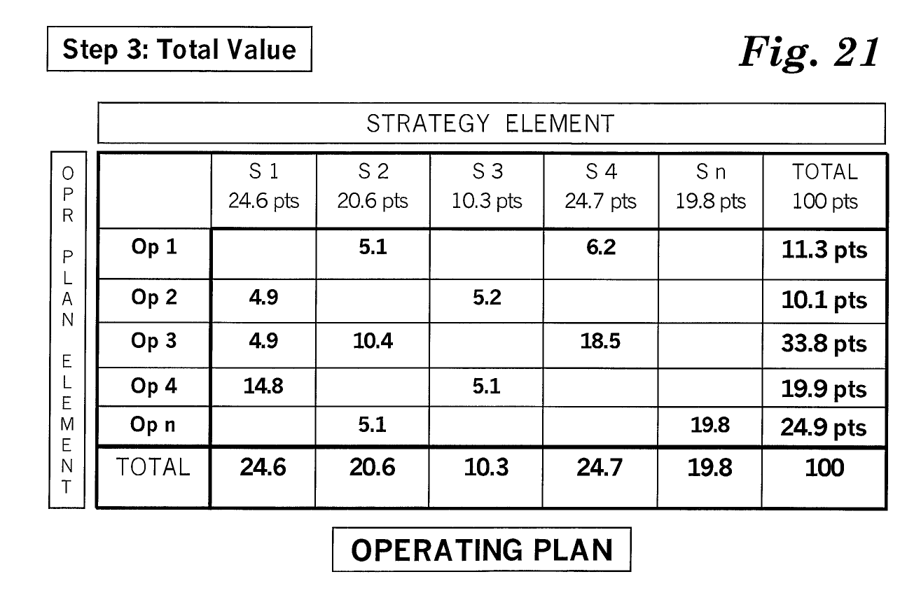

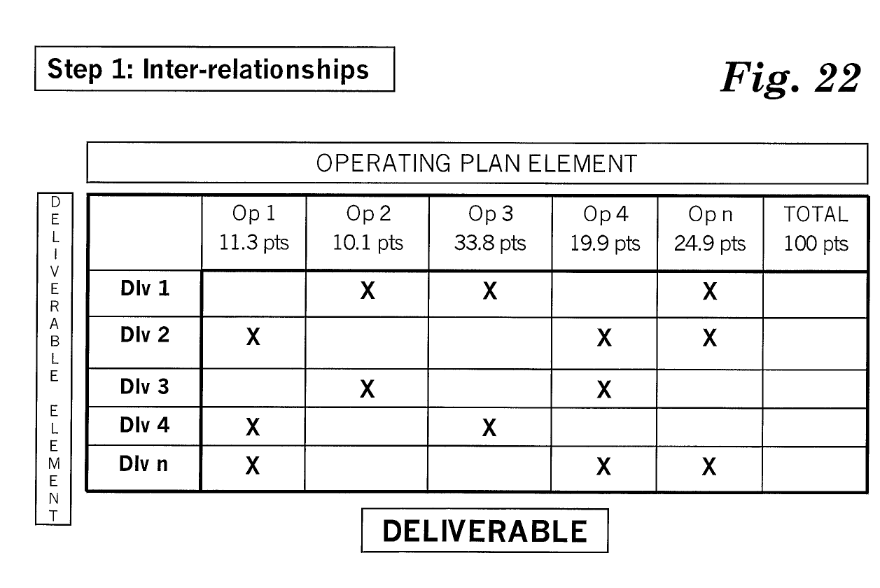

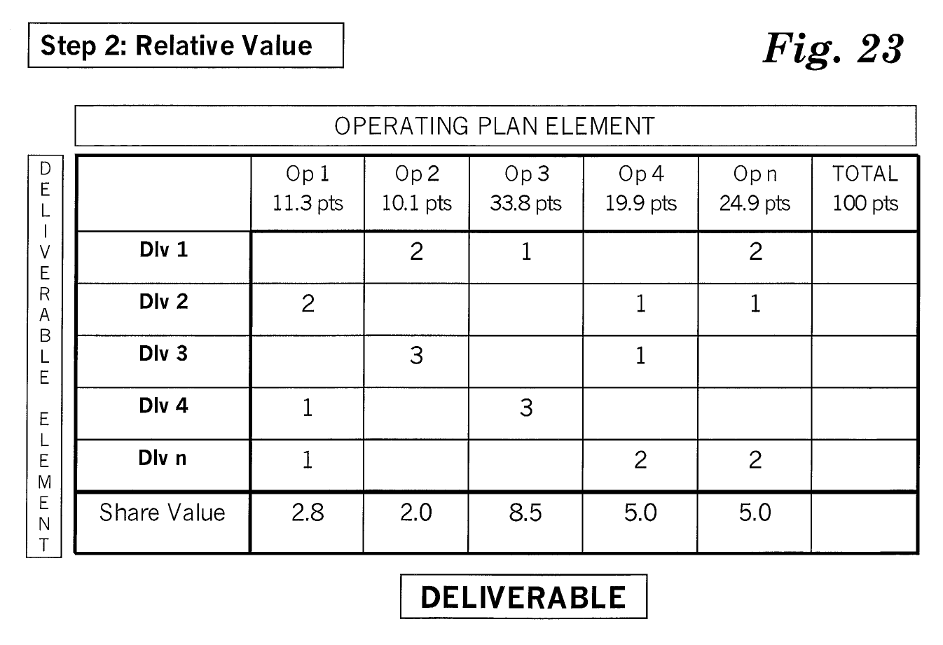

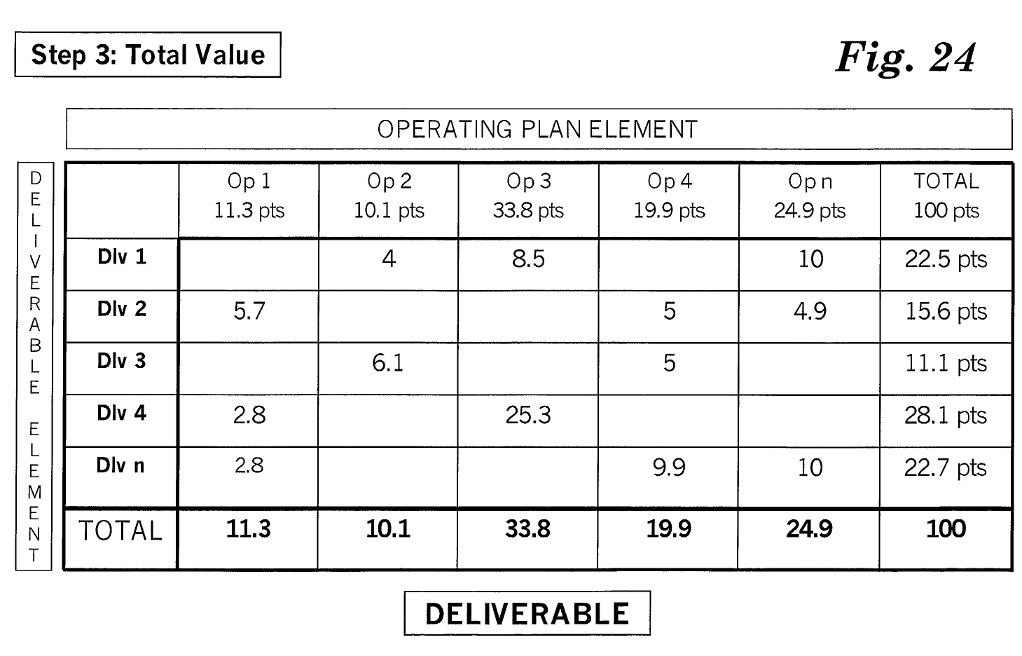

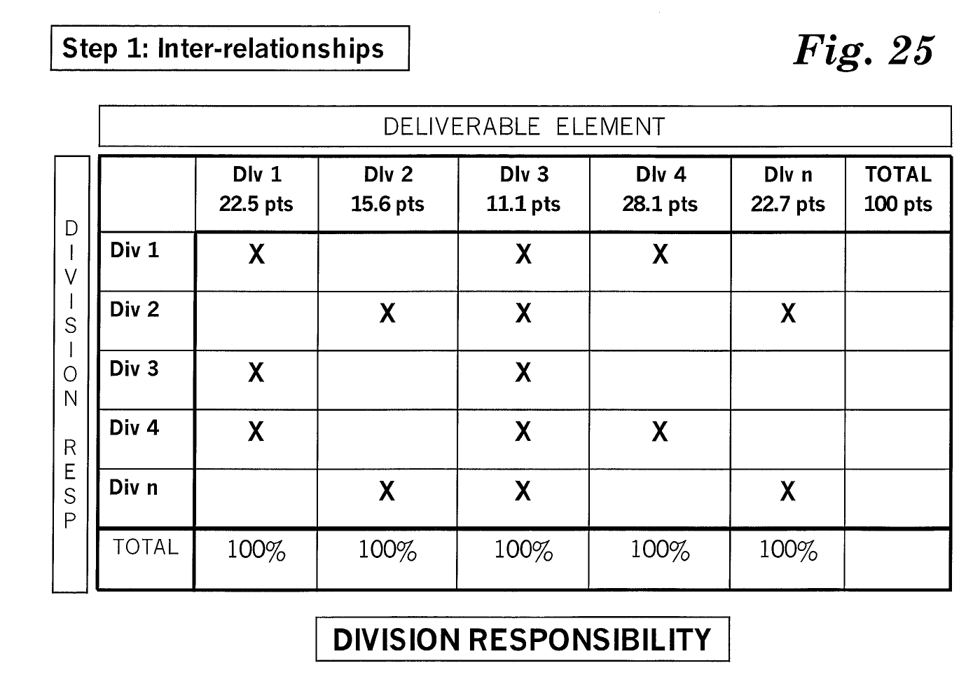

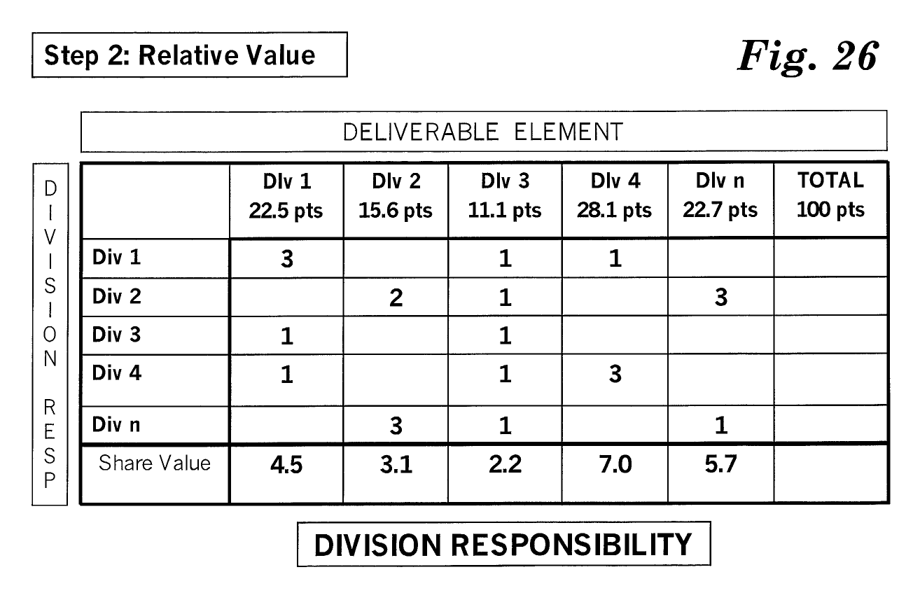

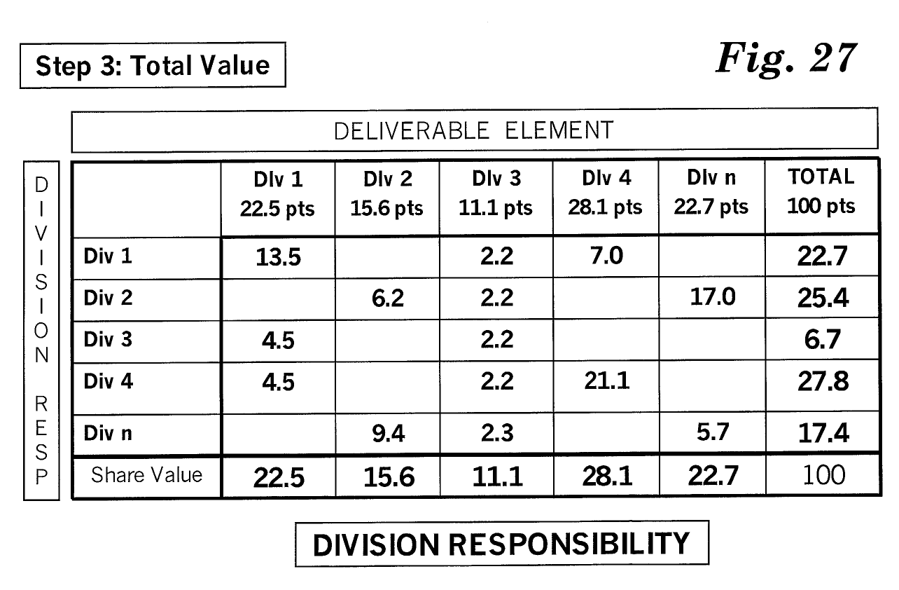

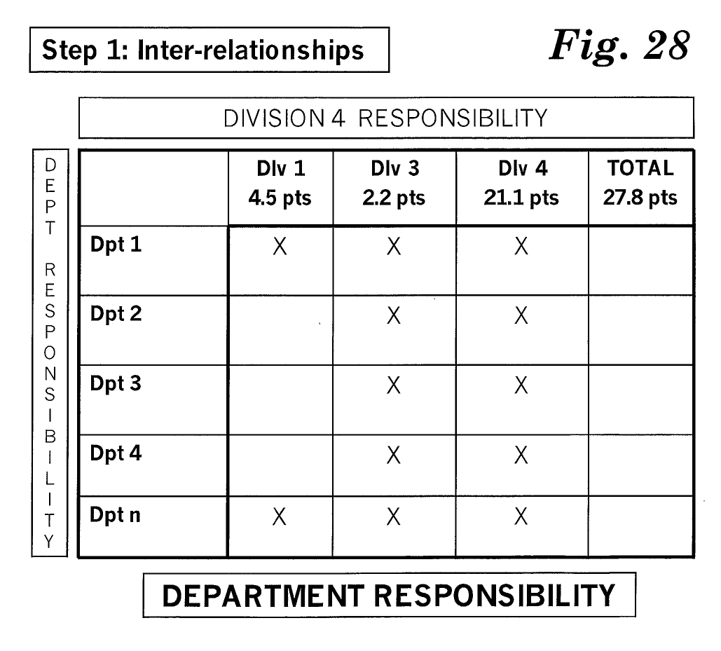

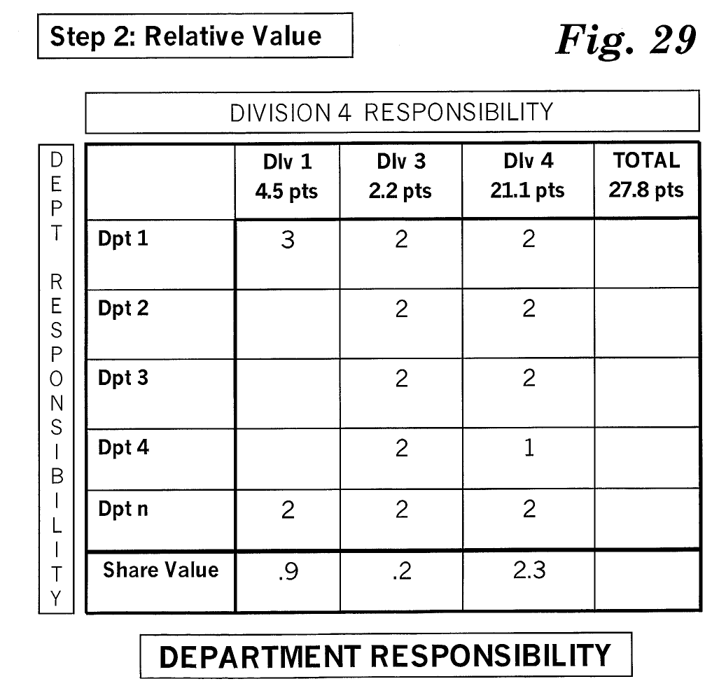

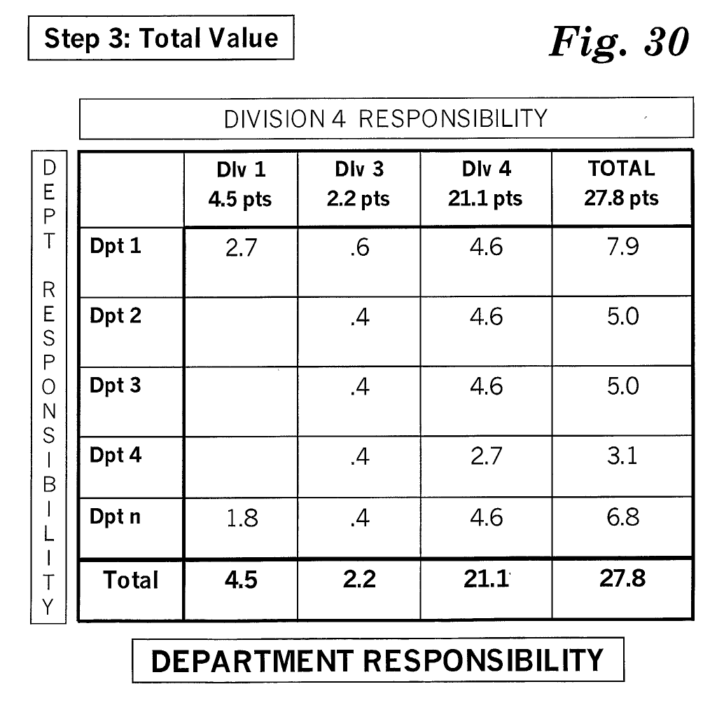

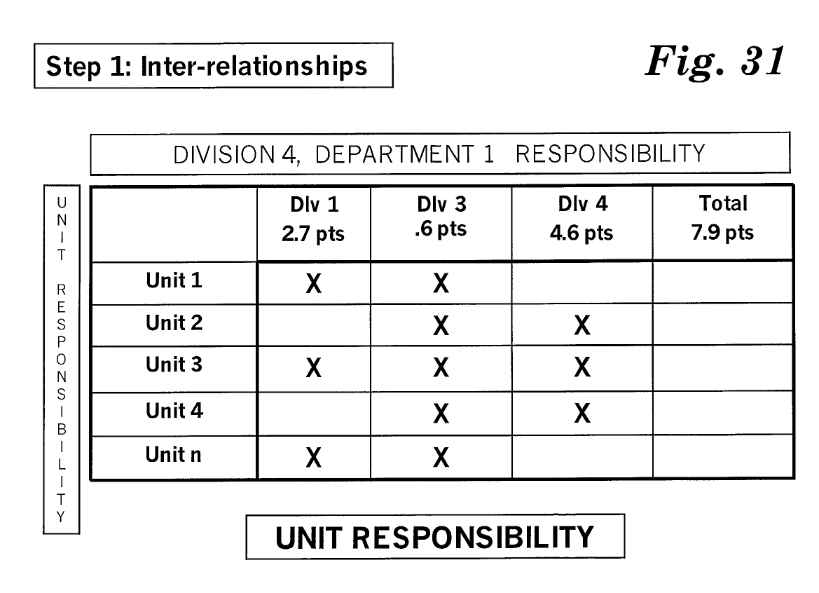

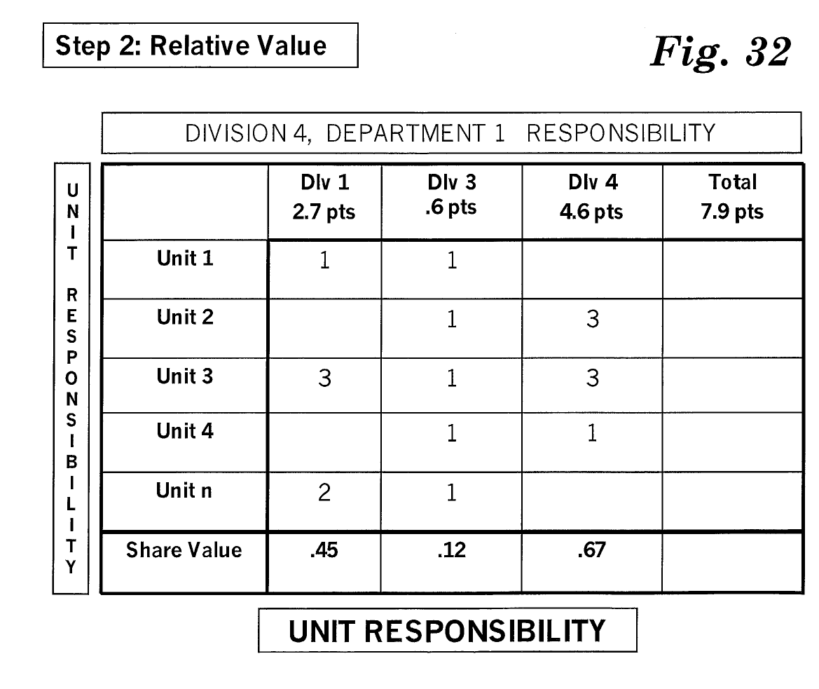

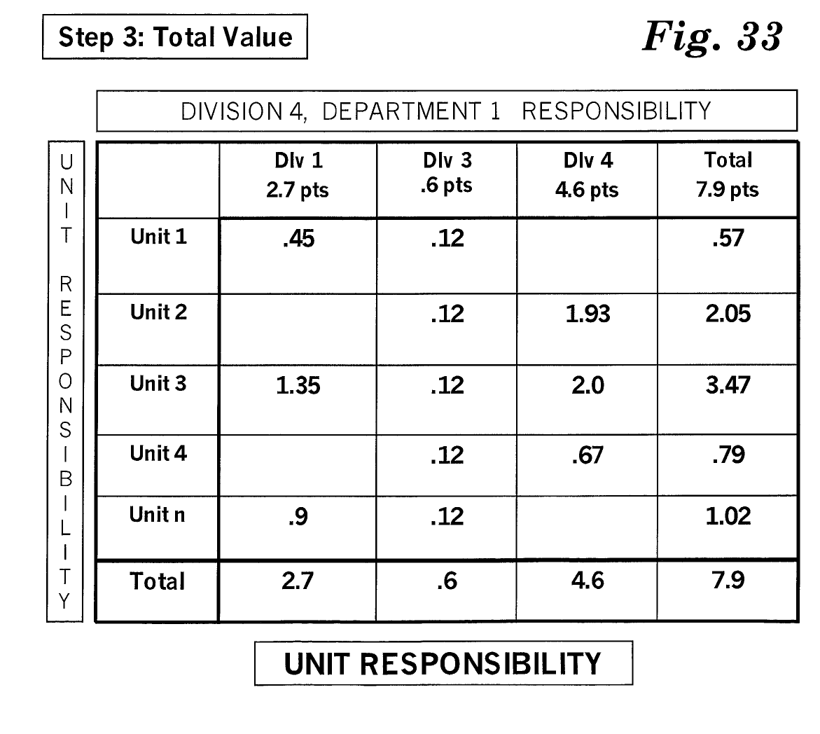

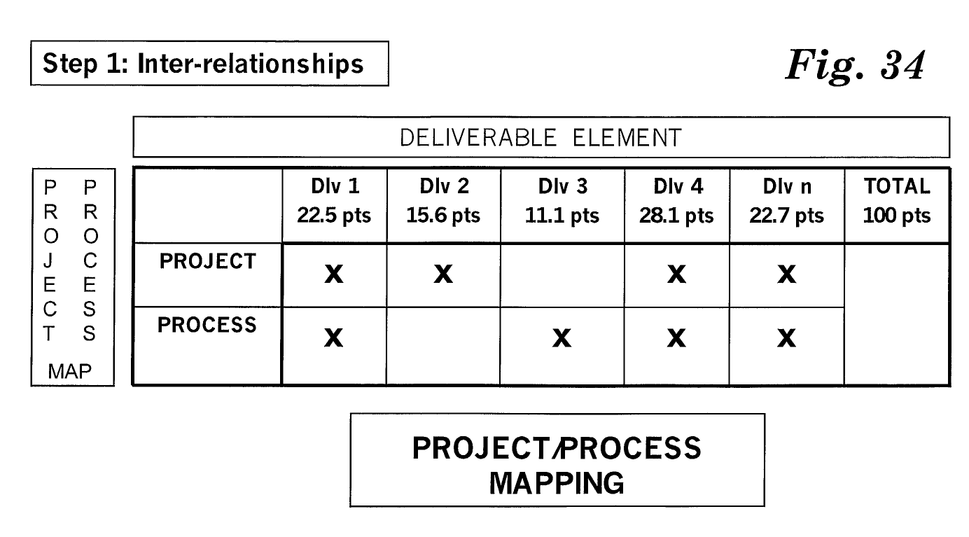

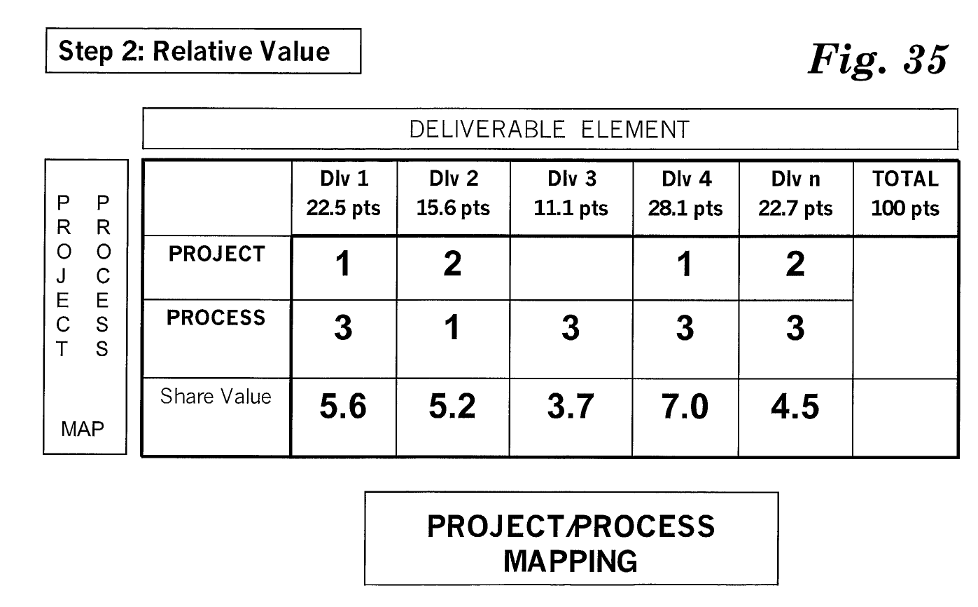

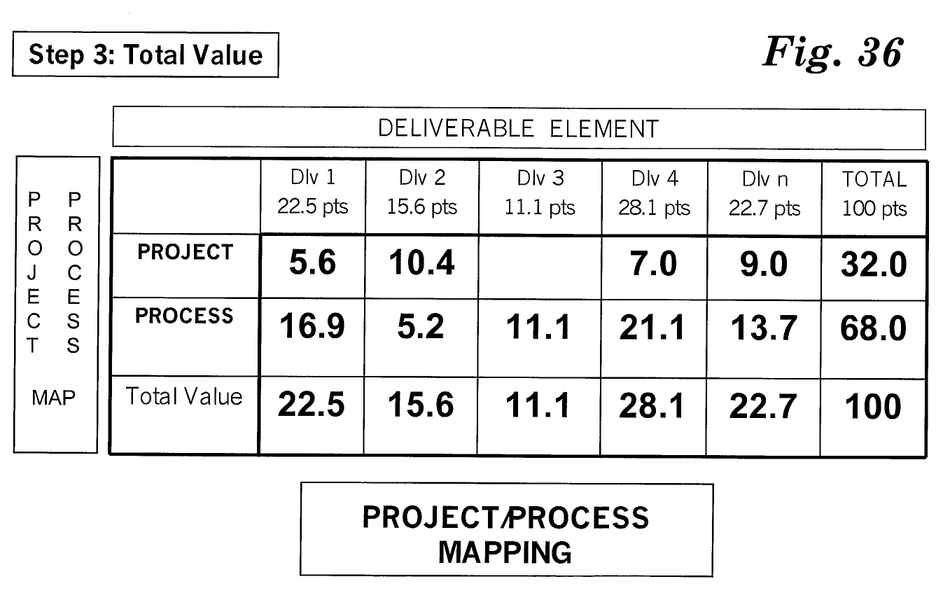

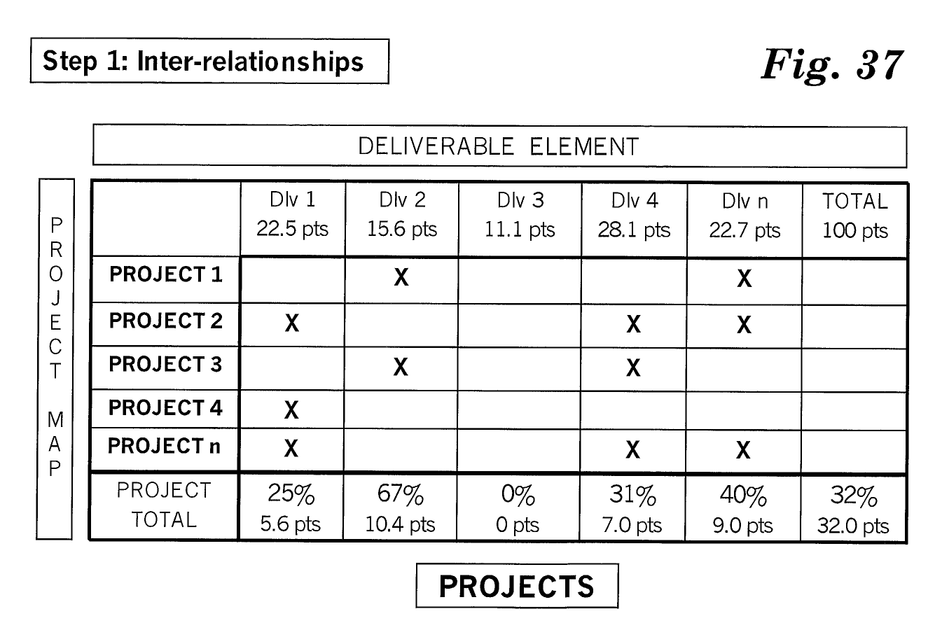

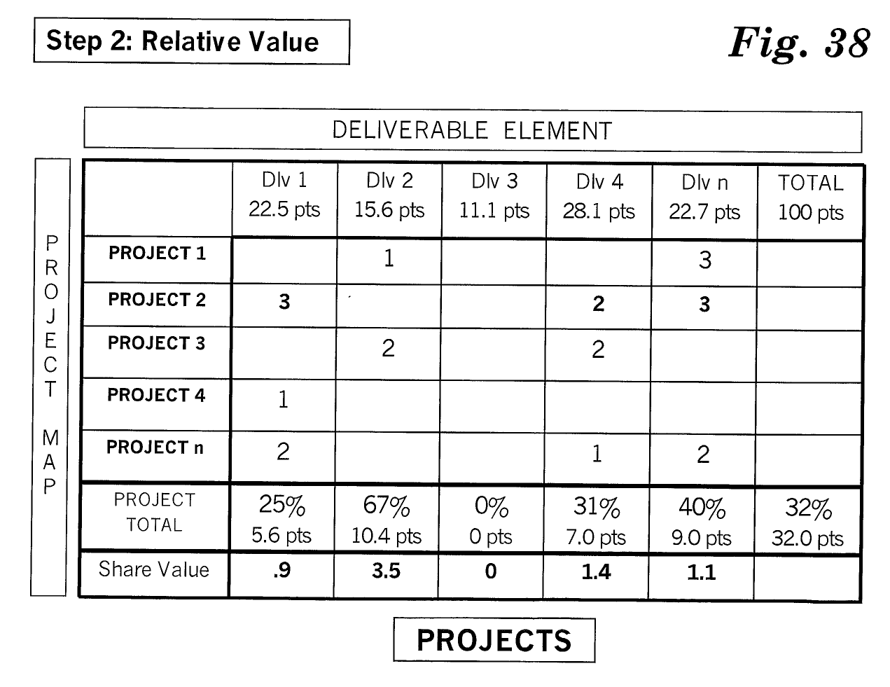

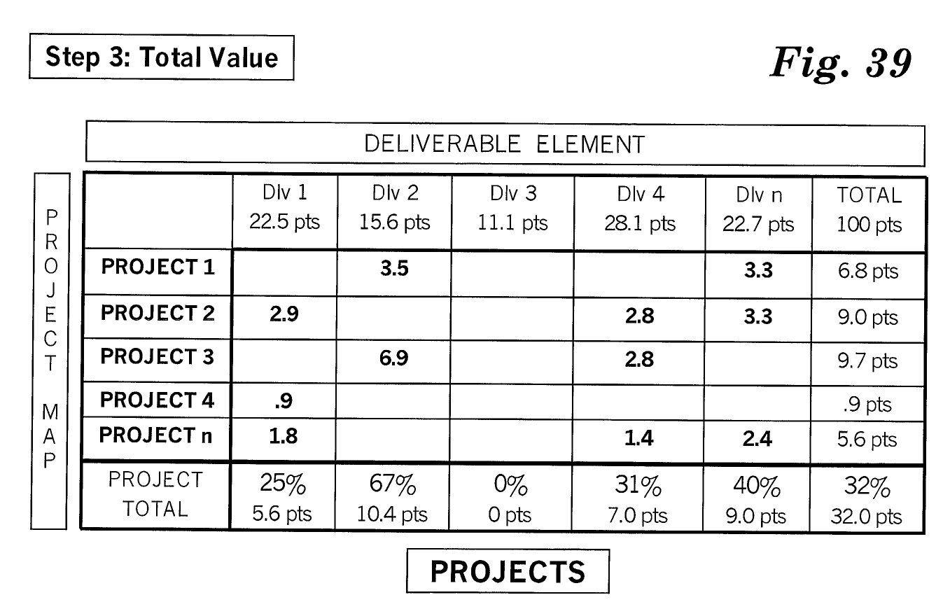

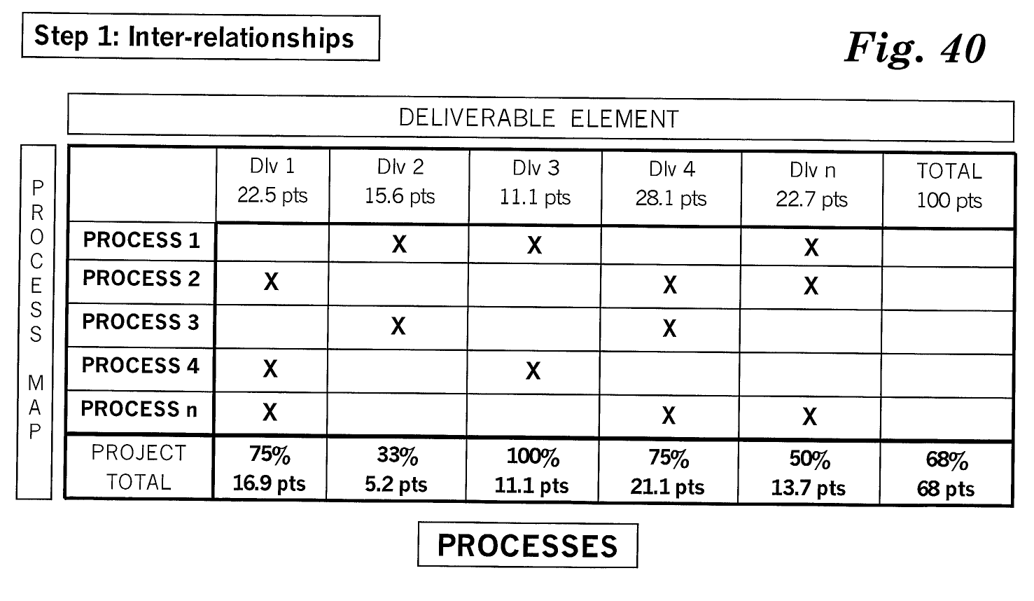

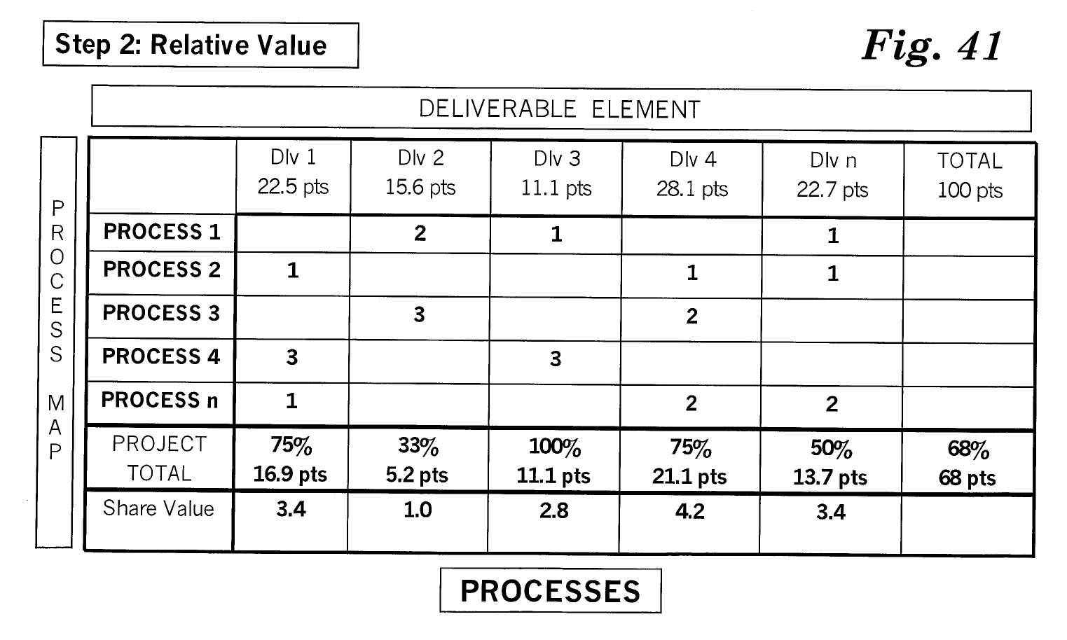

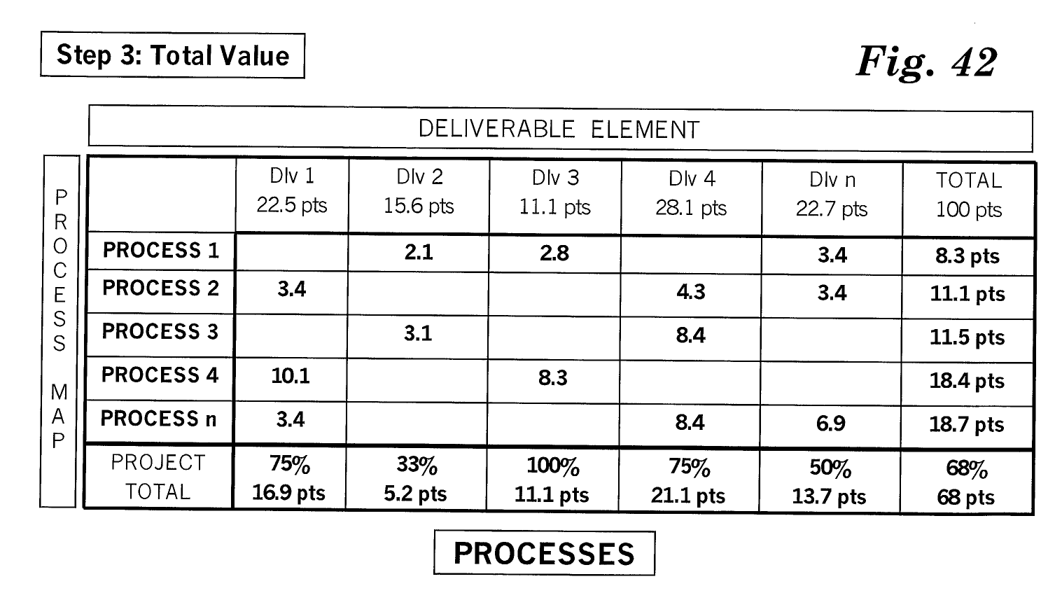

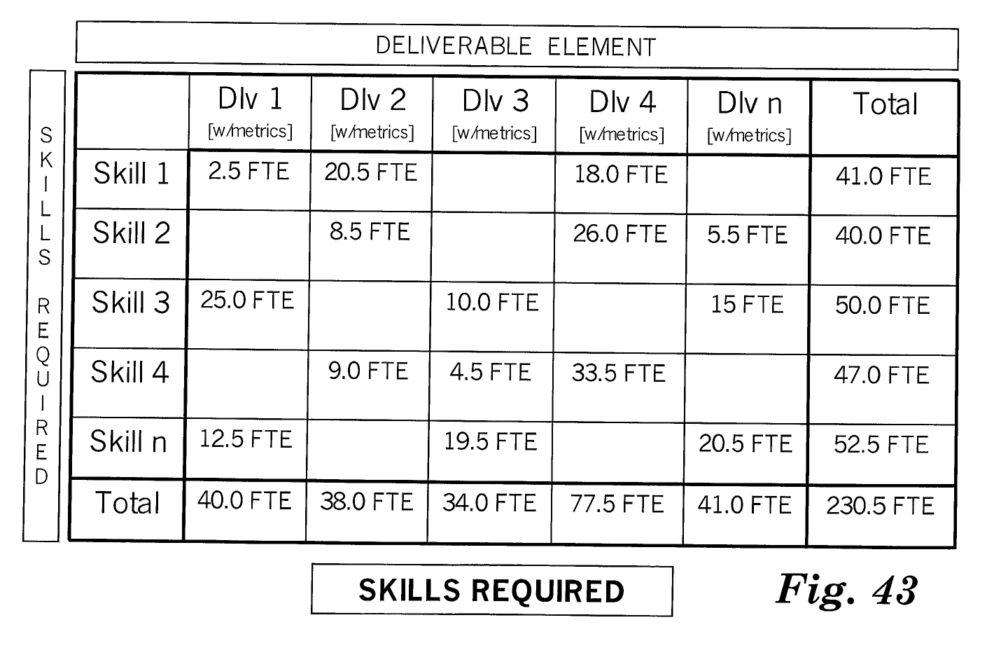

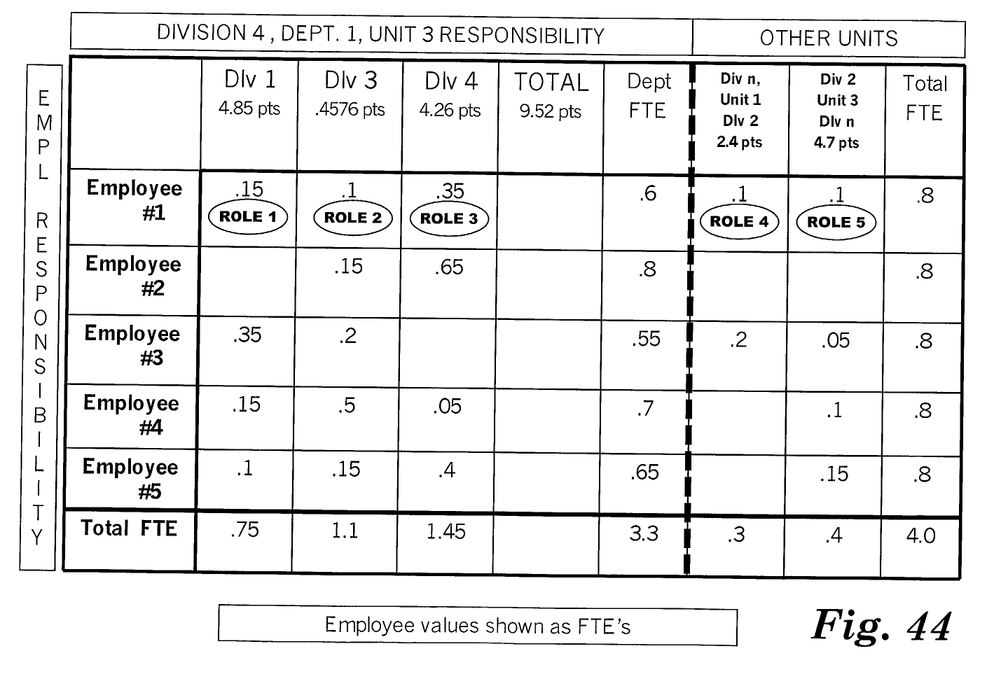

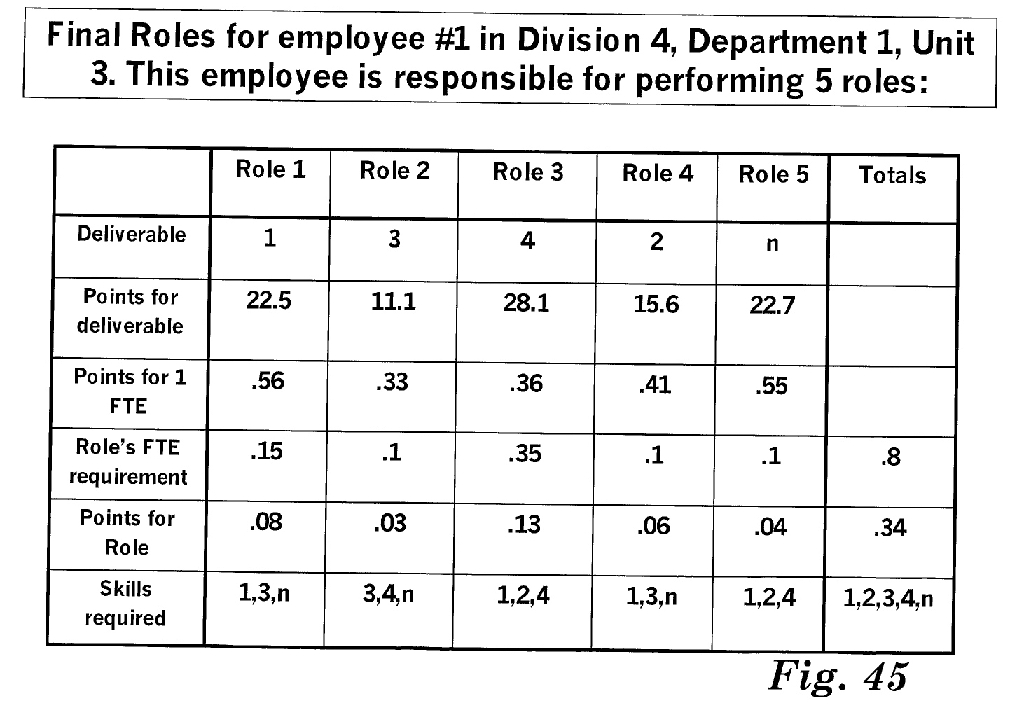

As shown in FIGS. 13-24, the table construction process continues as the organizational goals are broken down through the different levels of organizational definition: goals→outcomes, outcomes→blocks, blocks→strategy elements, strategy elements→operating plan element, and then operating plan element→deliverable. Thereafter, as shown in FIGS. 25-33, the deliverables can be broken down according to different levels of organizational structure (operating divisions, departments, etc.) which of course will depend on the structure of the particular organization. The deliverables can also be broken down and associated with particular projects and/or processes carried out by the organization to tie the deliverables to actual operation of the organization. This is shown in FIGS. 34-42. Finally, the deliverables are used along with assessed skills requirements and time requirements (expressed in FTE's) to determine individual roles for participants within the organization. This is illustrated in FIGS. 43-45.

The attached Specification Table Implementation Guide provides further explanation on the construction and use of the specification tables as a part of the consulting process.

### User Module Configuration

As mentioned above in connection with FIG. 3, the user module 52 consists of three primary components:

1. (Management Module 70) Gives access to the answers to the four most commonly asked questions by CEO's or leaders of an organization:

a) Is everything required by our organizational goals being done?

b) Is everything being done required by our organizational goals?

c) Do the individual success metrics add up to the metrics for success for the organization as a whole?

d) Are things being done the way I would want them to be done, throughout the organization?

2. (Participant Module 72) Accesses answers to the four questions most commonly asked by participants in an organization:

a) What am I doing here (supposed to be doing here)?

b) How am I doing in achieving the implied purpose?

c) How does what I am doing fit into the more general scheme of things (in this organization)?

d) How could I be doing things differently to improve the result?

The participant module 72 allows a user to view the elements or components of his/her roles generated from the organizational goals during the definition phase of the organizational consulting process. Appraisal and skills information can be made available via this interface, including access to current evaluations of performance or completion of roles. The participant can also view these roles in terms of their components of deliverables, metrics and skills/training information.

3. (Action Rule Module 74) This is an interface to an internal, rule-based model for reasoning hypothetically about the elements of the organizational consulting process definition of the organization. It is capable of giving advice as to how things could be done differently to improve results, from the point of view of the organizational goals.

Typically, intelligent systems are systems that give access to and reason about some objects and a list of specified relations between them. All such systems require an internal model of those objects and relations. The action rule module 74 is an intelligent system that reasons about the definition of an organization developed from the organizational goals during the organizational consulting process. It is a rule-based system whose objects are the encoding of action rules 62 entered into the system either manually or by automated extraction from the specification tables 60. As will be described below, the action rule module 74 has an internal model for reasoning about an organization's goals and about action that is designed to realize them. The relationships, or rules, encoded within the specification tables 60 are used to construct the action rules 62, and the action rule module 74 operates on these actions rules to reason about action consonant with organizational vision. The development of the action rules 62 can be done by user entry of the information, or, as illustrated in FIG. 3, can be implemented by a separate computer process 76 which develops the action rules based on the information contained in the specification tables. As will be discussed further below, the action rule module 74 also includes transaction logic 78 that provides an updating algorithm for processing and learning from the actual performance results fed back into the system.

The design of the action rule module 74 is three-tiered. These three tiers are user presentation, the action rule module logic, and database access. The internal model for reasoning about the organizational goals consists of two components:

i) the database of action rules 62;

ii) the transaction logic 78 that updates those database entries and is the feedback loop that enables the action rule module 74 to adapt its reasoning based upon its ‘experience’ (i.e., what rules have paid off previously).

The action rules 62 can be constructed as follows. If a rule is of the form a₁, . . . aₙ→v where the weights are denoted by w(a₁)=w₁, . . . w(aₙ)=wₙ and w(v)=w, then we enter into the action rule database the sequence:

(a₁(w₁), . . . aₙ(wₙ);v(w,e,k)) (5)

where e stands for this rule's equity and k for its escrow. The values of e and k are maintained in the set of fulfillment data 66 and are initialized and updated by the action rule module's update algorithms which will be described further below. In general, the updating is accomplished using a marketplace-based model in which the action rules 62 are classified as either buyers or sellers, with the action rules being considered sellers if all of their antecedents a₁, . . . aₙ have been achieved, and being otherwise considered buyers. The updating of escrow and equity is done based on the result of transactions between buyers and sellers using a measure of fitness to determine which buyer can supply the highest equity for the seller. Once the transaction is complete, the buyer transfers equity to the seller's escrow and the seller's antecedents are then marked as not achieved with the seller then being reclassified as a buyer searching for sellers of all of its antecedents. Once the organization has achieved the organizational goal with which a particular action rule is associated, the escrow for that action rule is moved into its equity. This transaction logic 78 will be described in greater detail further below.

### User Module Operation

The user module 52 can have a standard password-protected login procedure consisting of a login name and login password. The result of a successful login is access to a (login dependent) graphic user interface 56-58 that displays the choice between the three gateways to the user module 52 mentioned above: management module 70, participant module 72, and the action rule module 74. Using the action rules 62 that have been derived from the specification tables 60, the participant module 72 presents the user with a labeled tree-like diagram that represents the organizational consulting process definition of the organizational goals. All of the elemental components of that definition are displayed as nodes whose properties can then be accessed by selecting them individually. In this way the user arrives at an interactive context that can return meaningful responses to the following queries (with respect to any selected node in this representation):

1. What are we doing here?

2. What do we need to do to accomplish satisfactorily this element?

3. How are we doing (in realizing this element)?

4. What changes can be made in order to better accomplish this element?

The first two of these are answered directly from the information gathered and definition produced during the organizational consulting process. Suppose that the user has selected a node in that tree. The first of these is a request for the text component (a textual description) of the selected node in the organizational goal definition. The second asks for a listing of the names of the nodes immediately below the selected node, i.e., the elemental components of the next level seen as necessary for achieving the selected node. The third query involves access to the fulfillment data 66 which can be implemented as a relational database that contains regularly updated records of appraisal information. This appraisal information comprises evaluations of performance of the elemental components associated with the selected node. Current values of performance appraisals can be compared with the metrics associated with the corresponding role's deliverables to determine the relevant gaps between performance and vision-required tasks. The last query involves a more involved manipulation and transformation of the available data than the first three. The logic that generates this response is referred to as the action rule module logic and requires our carrying out reasoning processes on the action rules encoded in the action rule module database 62.

Recall that, during the definition phase of the organizational consulting process, action rules that arise (and that are sanctioned as compatible with the organizational goals) are embodied in the recording of data into the specification tables 60. These action rules 62 are then later more formally recorded during the action rule development 76. Each, in the required format, is entered from the specification tables 60 during action rule configuration. The function of the action rule module logic is to determine how and when the encoded records of action rules 62, as well as any attached numerical properties, are updated.

The action rules encoded in the action rule module database 62 describe a rule and a “value” that reflects its success in leading to the realization of organizational goals. This numerical value, written as its equity e, reflects the importance of that rule in achieving the ultimate goals of an organization. This equity value can initially be determined for any particular elemental component based on equity values originally assigned (as part of the consulting process) to the different organizational goals (V₁, . . . Vₙ) and then using the weights assigned to the elemental components in the chain between that particular component and the organizational goal(s) to which it relates. In this way, the initial equities will reflect system resources and drive action toward vision elements. The logic within the action rule module 74 specifies the precise sense in which action rules compete in the marketplace-based model, how their success is measured, and how that value influences equities of other action rules in the action rule module rule database. Suppose that a query of the fourth kind mentioned above is presented to the system:

What changes can be made in order to better accomplish this element of the organizational goals definition?

The selected elemental component is what is seen locally as that to be achieved. The elemental components immediately below it in the definition tree are what have to be achieved in order to achieve the selected element. The selected element and the set of elemental components below it, together with numeric information giving their respective weights, determine the action rule chosen to be applied during organizational planning. Other action rules with that same consequent element may well have been sanctioned, as compatible with the organizational goals, during the definition phase of the organizational consulting process. In fact, this is a typical collection of action rules that can be referred to as competing action rules. Thus, any set of sanctioned (recorded in the specification tables) action rules 62 with the same consequent element are called competing action rules.

To address a query of the form stated above, one could first consider the set of all sanctioned action rules with the selected elemental component as a consequent. This forms a set of competing action rules. To respond to the query the action rule module 74 returns that action rule 62 that has the selected elemental component as a consequent and that has the highest equity level e. In order to associate with each action rule 62 its importance in achieving organizational goals, each action rule is assigned its level of equity e and of escrow k, which are continuously updated. The initial equities e can be determined as explained above and the escrows are initially set to zero before any transactions take place. The performance data 64 is used to determine when elemental components such as deliverables have been achieved and this information is used to update the equity of those components and of the intermediate and upper level elemental components using the transaction logic described more fully below. Thus, as the elemental components at various levels are achieved by the organization, the equity of those components is increased.

The mechanism for updating the equity involves an ongoing set of transactions that involve the buying and selling of elemental components by the action rules 62. Recalling equation (5) given above, the action rules respectively buy and sell the elemental components that appear in the rule as inputs (i.e., antecedents on the left side) or outputs (i.e., succeedents on the right side). An input (antecedent) can only be purchased if it has been achieved, and those action rules that need antecedents are classified as buyers. When a buyer has purchased all of its antecedents, this necessarily means that, since all of its antecedents have been achieved, its succeedent has now been achieved. At this point, the action rule can be classified as a seller since its succeedent has been achieved. At that point, it can sell its succeedent elemental component to the next action rule up the chain towards those upper level elemental components that represent organizational goals. Once its succeedent has been sold, it is no longer considered achieved (since, in an ongoing organization, the various performance elements continuously need to be “reachieved”), and it is therefore reclassified as a buyer.

In the general case where an action rule needs to purchase more than one antecedent in order to output its succeedent on the right, buyers will be separated into distinct sets depending on the number of antecedents needed. The set of all action rules that are buyers for v, for example, is defined simultaneously for all messages v. The rule a₁, . . . aₙ→v is defined to be a buyer for each of the messages a₁, . . . aₙ at the initial stage. If this rule purchased a₁ at a previous stage, then it is only a buyer for the remaining items at the this stage.

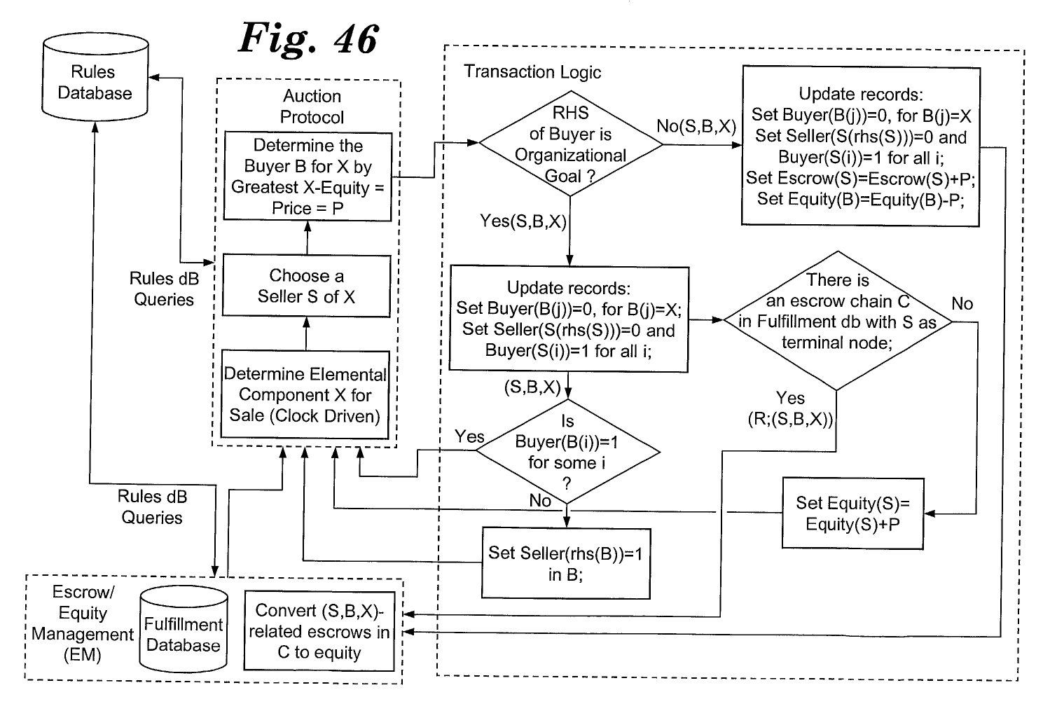

The current transaction (the one to be carried out at any given moment) is determined by choosing (on a rotating basis) a seller and then allowing the potential buyers to offer a bid. The buyer with highest equity e wins that bidding and, together with the seller determine the action rule participants in the current transaction. After that transaction is completed, the action rule participant that was previously a seller is now a buyer, and the action rule participant that was previously a buyer either remains a buyer (if it has additional antecedents to purchase) or is reclassified as a seller (if all of its antecedents have been purchased). The same process is then repeated. The concrete feature of a transaction is that the transaction price is deducted from the buyer's equity and added to the seller's equity, with one proviso: payment initially becomes part of the escrow k of the seller rather than a part of its equity e until such time as the purchased succeedent leads, via a chain of other transactions, to attainment of an action rule whose consequent (succeedent) is one of the organizational goals. Thus, a seller does not actually realize the payment as equity until attainment of one of the organizational goals to which that action rule relates. A particular implementation of this transaction process is diagrammed in FIG. 46.

The metaphor of a commercial market is frequently used in mathematical modeling in order to provide a familiar analogy. Here it is used to define the structure under which action rules behave as an agent that buys and sells the elemental components. In this context, the rules have the form of a conditional statement with an if-part and a then-part, i.e., a sequence of elemental components (antecedents) followed by an arrow that, in turn, is followed by a single component (succeedent). Thus each action rule is viewed as a potential buyer of the antecedents occurring on its left hand side and potential seller of the succeedent occurring on its right hand side. The role of the market is played here by an actual (or virtual) simulation of action according to this system of rules. At each stage of that simulation a single transaction is carried out. Whether or not a given action rule will be a buyer or a seller at the next stage of the simulation is determined by what it is currently and whether or not it participates in the current transaction.

The benefit of processing the above action rules using a marketplace-based transactions is that, once recorded and assigned an equity and an escrow (updated regularly using the results of their actual usage), the action rules and fulfillment data can be used by user module 52 to recommend action alternatives that, to date, have been most successful in realizing organizational goals. The transaction process helps guarantee that those action rules that best contribute to realizing organizational goals acquire the highest equity, and this quantitative information is then available to the user module 52 to provide feedback to the organization's participants regarding what needs to be accomplished to attain the organizational goals.

It will thus be apparent that there has been provided in accordance with the present invention a performance management system which achieves the aims and advantages specified herein. It will of course be understood that the foregoing description is of preferred exemplary embodiments of the invention and that the invention is not limited to the specific embodiments shown. Various changes and modifications will become apparent to those skilled in the art and all such variations and modifications are intended to come within the scope of the appended claims.

We claim:

1. A method of recording deliverables derived from an organization's goals, comprising the steps of:
separating each goal into a plurality of different levels of elemental components, with the different levels including a top level, a bottom level, and one or more intermediate levels, wherein the elemental components at each successively lower level provide a greater degree of specificity concerning the organizational activities required to achieve the goal than the elemental components at the preceding level, and wherein the elemental components at the bottom level comprise one or more sets of deliverables that represent specific organizational accomplishments that are required to achieve the organizational goal; and
recording relationships between elemental components at the different levels using a plurality of arrays to represent the relationships between the elemental components from those different levels, whereby the relationship between a deliverable and its associated organizational goal is represented by a combination of some or all of the arrays.

2. The method of claim 1, wherein said recording step further comprises creating each array using a horizontal axis of the array to identify elemental components at one level and using a vertical axis of the array to identify elemental components at another level.

3. The method of claim 1, further comprising the step of weighting each of a number of the elemental components with a value representative of that elemental component's contribution to one or more of the organization's goals.

4. The method of claim 3, wherein said weighting step further comprises determining weights for the deliverables by providing weights for each of the top level elemental components and using the top level weights to determine weights of elemental components at the intermediate and bottom levels.

5. The method of claim 1, wherein said separating step further comprises separating each of a number of top level and intermediate level elemental components into one or more lower level elemental components such that elemental components at a preceding level are associated with one or more elemental components at a succeeding level.

6. The method of claim 5, further comprising the step of determining a weight for each of a number of the elemental components at a succeeding level using the weight assigned to the associated elemental components from the preceding level.

7. A method of determining individual roles for participants in an organization using predetermined organizational goals, comprising the steps of:
identifying a set of deliverables required to achieve one or more organizational goals;
determining, for each of the deliverables, one or more individual roles for a participant within the organization; and
representing each individual role using its associated deliverable, one or more specified skills, and a numerical value indicative of the amount of the participant's time required to produce the associated deliverable using the specified skill(s).

8. The method of claim 7, further comprising the steps of:
quantitatively weighting each of the organizational goals;
determining a value for each deliverable using the quantitative weighting assigned to the goal associated with that deliverable; and
determining a value for each individual role that quantitatively represents the extent of the contribution of that role to its associated organizational goal(s).

9. A computer readable medium for use in providing a constructed definition of individual roles for participants within an organization, comprising:
a digital data storage medium having a computer readable code stored thereon;
wherein said computer readable code is operable upon execution to process one or more elemental components from a group of such components that together represent an organizational goal of the organization;
wherein said computer readable code is further operable upon execution and in response to processing the one or more elemental components to provide a representation of an individual role for a participant within the organization, with the representation including one or more specified deliverables, one or more specified skills, and a numerical value indicative of the amount of the participant's time required to produce the specified deliverable(s) using the specified skill(s).

10. A computer readable medium for use in managing performance of an organization, comprising:
a digital data storage medium having a computer readable code stored thereon;
a first set of data stored digitally on a data storage medium and having contained therein data concerning upper level and lower level elemental components of one or more organizational goals, wherein the upper level elemental components are represented within the first set of data as a combination of lower level elemental components, and wherein at least some of the elemental components comprise deliverables that represent organizational accomplishments that are required to achieve the organizational goals;
a second set of data stored digitally on a data storage medium and having contained therein data concerning actual performance of participants in the organization, with the second set of data including an identification of the deliverables that have been completed; and
a third set of data stored digitally on a data storage medium and having contained therein data concerning sequences of transactions that track completion of the deliverables and attainment of the organizational goals;
wherein the computer readable code is operable upon execution by a microprocessor to manage the third set of data based on data from the first and second sets of data.

11. A computer readable medium as defined in claim 10, wherein the computer readable code is operable to accept user queries and to respond to the user query by accessing data from one or more of the sets of data and returning an action rule representing performance requirements necessary to achieve one or more deliverables.

12. A computer readable medium as defined in claim 10, wherein the elemental components have an associated weight, escrow value, and equity value, and wherein, using data from the first and second data sets, the computer readable code is operable upon execution to determine whether the elemental components at different levels have been achieved and to change the escrow values of elemental components once they have been achieved.

13. A computer readable medium as defined in claim 12, wherein the computer readable code is operable upon execution to update the equity value of an elemental component using the escrow value for that elemental component when at least one organizational goal associated with that elemental component has been achieved.

14. A computer readable medium as defined in claim 12, wherein the first set of data includes a number of action rules representing performance requirements necessary to achieve one or more deliverables, and wherein each action rule includes an upper level elemental component and the combination of lower level elemental components that together represent that upper level elemental component.

15. A computer readable medium as defined in claim 14, wherein the action rule includes the weights and equity values associated with the lower level elemental components contained within the action rule.

16. A computer readable medium as defined in claim 14, wherein the lower level elemental components of an action rule comprise antecedents and the upper level elemental component of that action rule comprises a succeedent, and wherein the computer readable code is operable upon execution to classify that action rule as a seller if all of the antecedents of that action rule have been achieved and to otherwise classify that action rule as a buyer.

17. A computer readable medium as defined in claim 16, wherein the computer readable code is operable upon execution to:
(a) assign to each action rule a measure of fitness using its equity value and escrow value;
(b) select one of the sellers;
(c) identify those buyers for which the succeedent of the selected seller is an antecedent of the identified buyer;
(d) select from the set of identified buyers that buyer having the greatest fitness;
(e) change the data in the third set of data to indicate that the succeedent and antecedents of the seller have not been achieved and the corresponding antecedent of the selected buyer has been achieved;
(f) adjust the escrow value of the seller and the equity value of the selected buyer according to the fitness of that buyer; and
(g) reclassify the seller as a buyer.

18. A computer readable medium as defined in claim 10, wherein said first, second, and third data sets each comprise a separate database.

19. A computer readable medium as defined in claim 10, wherein said first, second, and third data sets each comprise one or more relational database tables.
